(19) United States
(12) Patent Application Publication
(10) Pub. No.: US 2026/0332995 A1
(43) Pub. Date: Oct. 22, 2026

(54) METHODS AND ARRANGEMENTS FOR NETWORK-BASED SENSING

(71) Applicant: Intel Corporation, Santa Clara, CA (US)

(72) Inventors: Alexandre Saso STOJANOVSKI, Paris (FR); Zongrui DING, Portland, OR (US); Fatemeh HAMIDI-SEPEHR, San Jose, CA (US); Qian LI, Portland, OR (US); Thomas LUETZENKIRCHEN, Santa Clara (CA); Sudeep PALAT, Cheltenham GLS (GB); Abhijeet KOLEKAR, Portland, OR (US); Thushara HEWAVITHANA, Tempe, AZ (US)

(73) Assignee: Intel Corporation, Santa Clara, CA (US)

(21) Appl. No.: 19/105,639

(22) PCT Filed: Sep. 30, 2023
(86) PCT No.: PCT/US2023/034243

§ 371 Date: Feb. 21, 2025

Related U.S. Application Data
(60) Provisional application No. 63/414,044, filed on Oct. 7, 2022.

(51) Int. Cl. H04W 4/38; H04W 4/021; H04W 24/10

(52) U.S. Cl. CPC H04W 4/38; H04W 4/021; H04W 24/10

(57) ABSTRACT

Logic may parse an application function (AF) request from an AF, the AF request comprising a first set of parameters, the first set of parameters comprising a first geographical area and a sensing type. Logic may identify a radio access network (RAN) node based on the first geographical area. Logic may send a sensing request to the RAN node, the sensing request comprising a second set of parameters to identify sensing information, the second set of parameters comprising a second geographical area and a sensing type. Logic may receive a sensing result from the RAN node based on the second set of parameters. And logic may process the sensing result based on the AF request to determine a sensing report; and send, to the AF, the sensing report via the network interface.

### CROSS REFERENCE TO RELATED APPLICATIONS

This application claims priority under 35 USC § 119 from U.S. Provisional Application No. 63/414,044, entitled “SUPPORT OF NETWORK-BASED SENSING FOR FIFTH-GENERATION (5G) SYSTEMS”, filed on Oct. 7, 2022, the subject matter of which is incorporated herein by reference.

### TECHNICAL FIELD

Embodiments herein relate to wireless communications, and more particularly, to network-based sensing in a cellular system.

### BACKGROUND

Wireless communications use electromagnetic waves to transmit and receive information. Electromagnetic waves are reflected and refracted off of objects, causing interference patterns indicative of the objects. The difference between the portion of the wave reflected and the portion of the wave refracted provides insight into the composition of the object. Wireless sensing technologies may analyze the interference patterns in the electromagnetic waves to detect static objects, moving objects, particulates in the air, and/or the like.

The rapid growth of wireless communication technologies and the increasing demand for high-quality data transmission have led to the development of advanced communication systems. With the proliferation of wireless technologies inherent to the deployment of cellular systems such as fifth generation cellular systems, components of the cellular system are constantly sending and receiving electromagnetic waves for communications and communications-related signaling.

### BRIEF DESCRIPTION OF THE DRAWINGS

FIG. 1 illustrates a communication network for service discovery and servicing for network-based sensing;

FIG. 2A illustrates an embodiment of a network in accordance with various embodiments such as the network in FIG. 1;

FIG. 2B illustrates an embodiment of a network in accordance with various embodiments such as the network in FIG. 1;

FIG. 3 illustrates an embodiment of a network in accordance with various embodiments such as the network in FIG. 1;

FIG. 4 illustrates an embodiment of a network in accordance with various embodiments such as the network in FIG. 1.

FIG. 5 illustrates an embodiment of a simplified block diagram of a base station and a user equipment (UE) that may carry out certain embodiments shown in FIGS. 1, 2A-2B, 3, and 4;

FIG. 6 depicts a flowchart of an embodiment for sense logic circuitry to perform network-based sensing such as the embodiments described in conjunction with FIGS. 1-5;

FIG. 7 depicts a flowchart of an embodiment for sense logic circuitry to perform network-based sensing such as the embodiments described in conjunction with FIGS. 1-6;

FIG. 8 depicts an embodiment of protocol entities that may be implemented in wireless communication devices;

FIG. 9 illustrates embodiments of the formats of PHY data units (PDUs) that may be transmitted by the PHY device via one or more antennas, encoded and decoded by a MAC entity such as the processors in FIG. 5 and the baseband circuitry in FIGS. 5, 13, and 14;

FIGS. 10A-B depicts embodiments of communication circuitry such as the components and modules shown in the user equipment and base station shown in FIG. 5;

FIG. 11 depicts an embodiment of a storage medium described herein;

FIG. 12 illustrates an architecture of a system of a network in accordance with some embodiments;

FIG. 13 illustrates example components of a device in accordance with some embodiments such as the base stations and UEs shown in FIGS. 1-12;

FIG. 14 illustrates example interfaces of baseband circuitry in accordance with some embodiments such as the baseband circuitry shown and/or discussed in conjunction with FIGS. 1-13; and

FIG. 15 depicts an embodiment of a block diagram of components to perform functionality described.

### DETAILED DESCRIPTION OF EMBODIMENTS

The following is a detailed description of embodiments depicted in the drawings. The detailed description covers all modifications, equivalents, and alternatives falling within the appended claims.

Integrating sensing and communication in a Third Generation Partnership Project (3GPP) cellular system such as a 5G system, a 6G system, and/or the like, allows for sensing to advantageously use, e.g., the 5G new radio (NR) wireless communication system and infrastructure that is already used for communication. Such embodiments may allow sensing information to be derived from RF-based and/or non-RF based sensors.

In fact, as part of their Release 19, 3GPP has initiated a study on support for Integrated Sensing and Communication (FS_Sensing; 3GPP tdoc SP-220705; 3GPP TR 22.837) that aims at adding a sensing functionality on the radio interface defined by 3GPP.

Wireless sensing technologies aim at acquiring information about a remote object and its characteristics without physically contacting it. The perception data of the object and its surroundings can be utilized for analysis, so that meaningful information about the object and its characteristics can be obtained. Another use of wireless sensing is for acquiring characteristics of the environment (e.g. weather monitoring).

Radar (radio detection and ranging) is a widely used wireless sensing technology that uses radio waves to determine the distance (range), angle, or instantaneous linear velocity of objects. There are other sensing technologies including non-RF sensors, which have been used in other areas, e.g., time-of-flight (ToF) cameras, accelerometers, gyroscopes, and Lidar.

In general, combining wireless sensing with communications systems and infrastructure may facilitate communication assisted sensing where a 5G communication system provides sensing services, or sensing assisted communication. Sensing assisted communication may involve sensing information related to a communication channel or an environment to improve the communication service of the 5G system or later system. For instance, the sensing information can be used to assist radio resource management, interference mitigation, beam management, mobility, etc.

Integrated sensing and communication (ISAC) involves the simultaneous use of radio frequency (RF) signals for both sensing and communication purposes. This integration can lead to improved spectrum efficiency, reduced latency, and enhanced reliability in various applications. Integrated Sensing and Communication is particularly relevant in the context of mobile operators, User Equipment (UE) vendors, automobile vendors, and subscribers, as it can significantly enhance the overall user experience, improve network efficiency, and enable new business opportunities.

Integrated sensing and communication enables 3GPP network to evolve from communication network to communication sensing integrated network. It connects the cyber world and the physical world and provides the key technical foundation for the integration of virtual world and reality, which expands 3GPP technical scope.

There are multiple market segments and verticals where network-based sensing services may be beneficial. For instance, network-based sensing services may be beneficial for intelligent transportation, aviation, enterprise, smart city, smart home, factories, consumer applications, extended reality (XR), public sector applications, and/or the like.

Sensing applications such as intruder detection applications (highway, railway, restricted area for UAV, yard and home), monitoring applications (rainfall, tourist, flood, respiration and sport), navigation assistance applications, real-time map generation applications, collision avoidance application, etc., can be achieved via, e.g., a 5G system using different sensing methods to fulfil the required sensing accuracy. Sensing can be supported for a target object (and its environment) with or without UE on board over licensed or unlicensed spectrum for commercial, V2X, public safety and emergency services use cases.

Examples for use of 5GS network-based sensing to provide communication assisted sensing services comprise:
Environment Real-time monitoring (twinning): Using wireless signals to reconstruct the environment map to further improve positioning accuracy and enable environment related applications, such as realizing an array of real-time monitoring related applications including dynamic 3D map for driving assistance, pedestrian flow statistics, intrusion detection, traffic detection and/or the like.
Autonomous vehicles/Unmanned Aerial Vehicle (UAV): Autonomous vehicles/UAV applications have some common functional requirements. For example, Autonomous vehicles/UAV shall support Detect and Avoid (DAA) to avoid obstacles. Meanwhile, Autonomous vehicles/UAV shall have the capability to monitor path information, like selecting routes, complying with traffic regulations.
Air pollution or weather monitoring: The quality of the received wireless signal displays different attenuation characteristics with changes in air humidity, air particulate matter (PM) concentration, carrier frequency, and/or the like, which can be used for weather or air quality detection.
Indoor Health Care and Intrusion Detection. Respiration rate estimation, breathing depth estimation, apnea detection, elders' vital sign monitoring, and indoor intrusion detection can be realized.

Embodiments may enable network-based sensing in cellular networks via a centralized function referred to herein as a Sensing Service Management Function (SSMF). The SSMF interacts (via a Network Exposure Function (NEF)) with an Application Function (AF), such as a third-party AF, to provide the AF with sensing results or sensing reports. The SSMF may also interact with one or more Radio Access Network (RAN) nodes (directly or via an Access and Mobility Management Function (AMF)) to collect sensing results from each of the one or more RAN nodes. In many embodiments, the SSMF issues individual requests to each RAN node, collects the RAN node sensing results, processes the RAN node results, and delivers a combined or synthetic sensing report to the AF based on the sensing results from the one or more RAN nodes. In some embodiments, the NEF may combine SSMF sensing reports from multiple SSMFs to generate the synthetic sensing report to the AF.

In some embodiments, the SSMF may be a core network function that is a logical function of the core cellular network and that can be physically located anywhere within the core network. In some embodiments, the SSMF may be physically located in one or more RAN nodes. In many embodiments, instances of the SSMF may be physically located in multiple locations of the network. In further embodiments, the functionality of the SSMF may be distributed in multiple physical locations of the network.

Physical instantiations of embodiments described herein (including e.g., the NEF, Unified Data Repository (UDR), SSMF, AMF, RAN nodes, and interfaces or reference points there between) are referred to as sense logic circuitry to identify locations of circuitry, such as memory and/or processing circuitry, of the embodiments. Each instance of the sense logic circuitry may implement some of or all the functionality related to network-based sensing described herein.

In many embodiments, the sense logic circuitry may address service authorization and control, discovery and selection of sensing devices/entities (e.g. UE, gNB), sensing measurement, data collection, and result calculation based on the collected data, sensing result exposure, and/or mobility and service continuity for periodic and triggered ISAC service.

Various embodiments may be designed to address different technical problems associated cellular networks is a lack of a capability to utilize network-based sensing to improve communications via sensing assisted communications; a lack of a capability to offer service discovery and servicing for network-based sensing; and a lack of a capability for detection of an object shape, an object velocity, air pollution intensity, and/or rainfall intensity; a lack of a capability to provide services to provide reporting of a map indicative of rainfall intensity based on a geographical area, a map indicative of air pollution based on a geographical area, an object shape, and/or an object velocity; and/or the like.

Different technical problems such as those discussed above may be addressed by one or more different embodiments. Embodiments may address one or more of these problems associated with a lack of a capability to utilize network-based sensing. For instance, some embodiments that address with a lack of a capability to utilize network-based sensing may do so by one or more different technical means, such as, parse an application function (AF) request from an AF, the AF request comprising a first set of parameters, the first set of parameters comprising a first geographical area and a sensing type; identify a radio access network (RAN) node based on the first geographical area; send a sensing request to the RAN node, the sensing request comprising a second set of parameters to identify sensing information, the second set of parameters comprising a second geographical area and a sensing type; receive a sensing result from the RAN node based on the second set of parameters; process the sensing result based on the AF request to determine a sensing report; send, to the AF, the sensing report via the network interface; and/or the like.

Several embodiments comprise systems with multiple processor cores such as central servers, access points, and/or stations (STAs) such as modems, routers, switches, servers, workstations, netbooks, mobile devices (Laptop, Smart Phone, Tablet, and the like), sensors, meters, controls, instruments, monitors, home or office appliances, Internet of Things (IoT) gear (watches, glasses, headphones, cameras, and the like), and the like. Some embodiments may provide, e.g., indoor and/or outdoor “smart” grid and sensor services. In various embodiments, these devices relate to specific applications such as healthcare, home, commercial office and retail, security, and industrial automation and monitoring applications, as well as vehicle applications (automobiles, self-driving vehicles, airplanes, drones, and the like), and the like.

The techniques disclosed herein may involve transmission of data over one or more wireless connections using one or more wireless mobile broadband technologies. For example, various embodiments may involve transmissions over one or more wireless connections according to one or more 3rd Generation Partnership Project (3GPP), 3GPP Long Term Evolution (LTE), 3GPP LTE-Advanced (LTE-A), 4G LTE, 5G New Radio (NR) and/or 6G, technologies and/or standards, including their revisions, progeny and variants. Various embodiments may additionally or alternatively involve transmissions according to one or more Global System for Mobile Communications (GSM)/Enhanced Data Rates for GSM Evolution (EDGE), Universal Mobile Telecommunications System (UMTS)/High Speed Packet Access (HSPA), and/or GSM with General Packet Radio Service (GPRS) system (GSM/GPRS) technologies and/or standards, including their revisions, progeny and variants.

Examples of wireless mobile broadband technologies and/or standards may also include, without limitation, any of the Institute of Electrical and Electronics Engineers (IEEE) 802.16 wireless broadband standards such as IEEE 802.16m and/or 802.16p, International Mobile Telecommunications Advanced (IMT-ADV), Worldwide Interoperability for Microwave Access (WiMAX) and/or WiMAX II, Code Division Multiple Access (CDMA) 2000 (e.g., CDMA2000 1xRTT, CDMA 2000 EV-DO, CDMA EV-DV, and so forth), High Performance Radio Metropolitan Area Network (HIPERMAN), Wireless Broadband (WiBro), High Speed Downlink Packet Access (HSDPA), High Speed Orthogonal Frequency-Division Multiplexing (OFDM) Packet Access (HSOPA), High-Speed Uplink Packet Access (HSUPA) technologies and/or standards, including their revisions, progeny and variants.

Some embodiments may additionally perform wireless communications according to other wireless communications technologies and/or standards. Examples of other wireless communications technologies and/or standards that may be used in various embodiments may include, without limitation, other IEEE wireless communication standards such as the IEEE 802.11-5220, IEEE 802.11ax-5221, IEEE 802.11ay-5221, IEEE 802.11ba-5221, and/or other specifications and standards, such as specifications developed by the Wi-Fi Alliance (WFA) Neighbor Awareness Networking (NAN) Task Group, machine-type communications (MTC) standards such as those embodied in 3GPP Technical Report (TR) 23.887, 3GPP Technical Specification (TS) 22.368, 3GPP TS 23.682, 3GPP TS 36.133, 3GPP TS 36.306, 3GPP TS 36.321, 3GPP TS. 331, 3GPP TS 38.133, 3GPP TS 38.306, 3GPP TS 38.321, 38.214, and/or 3GPP TS 38.331, and/or near-field communication (NFC) standards such as standards developed by the NFC Forum, including any revisions, progeny, and/or variants of any of the above. The embodiments are not limited to these examples.

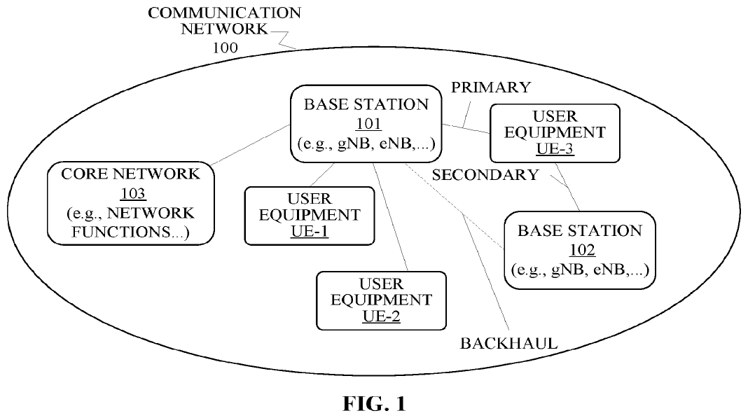

FIG. 1 illustrates a communication network 100 for service discovery and servicing for network-based sensing. The communication network 100 is an Orthogonal Frequency Division Multiplex (OFDM) network comprising a primary base station 101, a secondary base station 102, a cloud-based service 103, a first user equipment UE-1, a second user equipment UE-2, and a third user equipment UE-3. In a 3GPP system based on an Orthogonal Frequency Division Multiple Access (OFDMA) downlink, the radio resource is partitioned into subframes in time domain and each subframe comprises of two slots. Each OFDMA symbol further consists of a count of OFDMA subcarriers in frequency domain depending on the system (or carrier) bandwidth. The basic unit of the resource grid is called Resource Element (RE), which spans an OFDMA subcarrier over one OFDMA symbol. Resource blocks (RBs) comprise a group of REs, where each RB may comprise, e.g., 12 consecutive subcarriers in one slot.

Several physical downlink channels and reference signals use a set of resource elements carrying information originating from higher layers of code. For downlink channels, the Physical Downlink Shared Channel (PDSCH) is the main data-bearing downlink channel, while the Physical Downlink Control Channel (PDCCH) may carry downlink control information (DCI). The control information may include scheduling decision, information related to reference signal information, rules forming the corresponding transport block (TB) to be carried by PDSCH, and power control command. UEs may use cell-specific reference signals (CRS) for the demodulation of control/data channels in non-precoded or codebook-based precoded transmission modes, radio link monitoring and measurements of channel state information (CSI) feedback. UEs may use UE-specific reference signals (DM-RS) for the demodulation of control/data channels in non-codebook-based precoded transmission modes.

The communication network 100 may comprise a cell such as a micro-cell or a macro-cell and the base station 101 may provide wireless service to UEs within the cell, which may also be referred to as the service area for the base station 101. The base station 102 may provide wireless service to UEs within another cell located adjacent to or overlapping the cell. In other embodiments, the communication network 100 may comprise a macro-cell and the base station 102 may operate a smaller cell within the macro-cell such as a micro-cell or a picocell. Other examples of a small cell may include, without limitation, a micro-cell, a femto-cell, or another type of smaller-sized cell.

In various embodiments, the base station 101 and the base station 102 may communicate over a backhaul. In some embodiments, the backhaul may comprise a wired backhaul. In various other embodiments, backhaul may comprise a wireless backhaul. In some embodiments, the backhaul may comprise an Xn interface or a F1 interface, which are interfaces defined between two RAN nodes or base stations such as the backhaul between the base station 101 and the base station 102. The Xn interface is an interface for gNBs and the F1 interface is an interface for gNB-Distributed units (DUs) if the architecture of the communication network 100 is a central unit/distributed unit (CU/DU) architecture. For instance, the base station 101 may comprise a CU and the base station 102 may comprise a DU in some embodiments. In other embodiments, both the base stations 101 and 102 may comprise eNBs or gNBs.

The base stations 101 and 102 may communicate protocol data units (PDUs) via the backhaul. As an example, for the Xn interface, the base station 101 may transmit or share control plane PDUs via an Xn-C interface and may transmit or share data PDUs via a Xn-U interface. For the F1 interface, the base station 101 may transmit or share control plane PDUs via an F1-C interface and may transmit or share data PDUs via a F1-U interface. Note that discussions herein about signaling, sharing, receiving, or transmitting via a Xn interface may refer to signaling, sharing, receiving, or transmitting via the Xn-C interface, the Xn-U interface, or a combination thereof. Similarly, discussions herein about signaling, sharing, receiving, or transmitting via a F1 interface may refer to signaling, sharing, receiving, or transmitting via the F1-C interface, the F1-U interface, or a combination thereof.

In some embodiments, the base stations 101 and 102 may comprise sense logic circuitry to enable service discovery and servicing for network-based sensing. The sense logic circuitry may reside in the primary base station 101, the secondary base station 102, and the core network 103 of network 100 (such as a 5GC or a 6GC).

The core network 103 may comprise network functions such a network exposure function (NEF) to provide network-based sensing services to application functions (AFs) such as third-party AFs. The core network 103 may also comprise a sensing service management function (SSMF) to distribute sensing requests to appropriate base stations or RANs such as base station 101 and base station 102, collect sensing results from the base stations, and send a sensing report to the AF based on the sensing results. In some embodiments, the core network 103 may comprise more than one SSMF to cover different geographical regions such as different states.

The NEF may receive requests for service discovery and requests for network-based sensing. After authentication and authorization of a sensing request from an AF, if there are SSMFs assigned to different geographical regions, the NEF may identify the one or more SSMFs that can produce a sensing report for the geographical area associated with the AF request and may then send the AF request to the one or more SSMFs for processing.

The SSMFs may receive the AF request from the NEF and identify one or more base stations with service areas overlaying or within the geographical area associated with the AF request. The SSMFs may send sensing requests to the one or more base stations such as base station 101 and base station 102 for collection and processing of sensor data.

After receipt of the sensing requests, the base stations may perform sensing by transmission of directional radio signals and reception of echoes of the transmissions reflected back to the base stations. Based on reception of the echoes, the base stations may process the echoes (referred to herein as sensor data) to determine characteristics of the environment about the base stations such as characteristic of objects. The objects may include, e.g., vehicles or other objects on a highway, railroad cars on a railway, static objects that may cause interference for communications, objects that may be obstructions on the highway or railway, objects that may represent intruders within a home or office, objects such as particulates or rain drops in air, locations of the particulates or rain drops in the air, and/or the like.

The base stations may process the sensor data to identify the characteristics of the objects velocity vectors, speed, distance, angular velocity, size, shape, location, and/or the like. In some embodiments, the base stations may process the sensor data to generate a sensor result to send to the SSMFs.

In some embodiments, the base stations may process the sensor data further to determine events associated with the environment. In further embodiments, the one or more SSMFs may process the sensor results from the one or more base stations to determine events associated with the environment.

In many embodiments, the one or more SSMFs may process the sensor results from the base stations to determine a sensing report such as a grouping of the sensor results. The SSMFs may send the sensing reports to the NEF and the NEF may send the sensor reports to the AF that requested the network-based sensing (also referred to as the AF invoker).

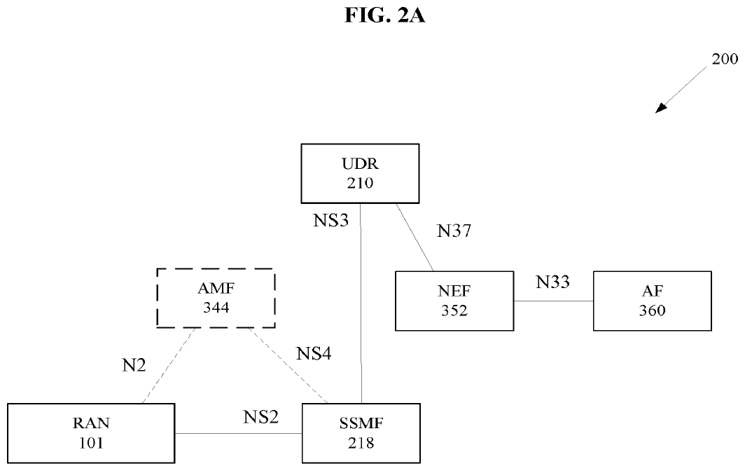

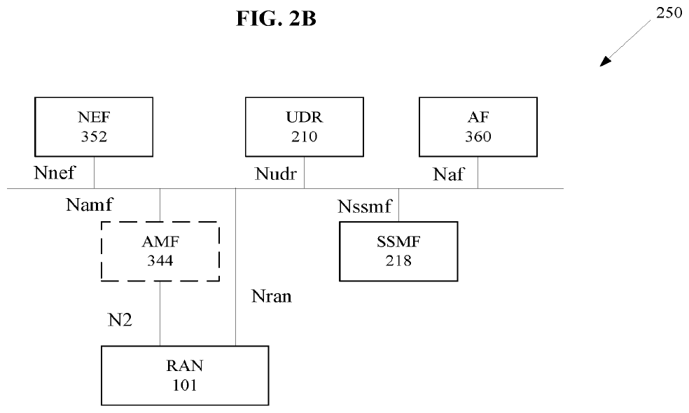

FIG. 2A illustrates an embodiment of a network 200 in accordance with various embodiments such as the network 100 in FIG. 1. The network 200 is depicted in a reference-point representation of network consumer functions and producer functions with point-to-point interfaces. An application function (AF) 360 may comprise a network consumer function that makes an AF request for sensing and collects or receives the results of the sensing. The AF request for sensing may comprise parameters such as the sensing type, the geographical area for sensing, and possibly additional parameters. The AF 360 may pass the AF request for sensing to the Network Exposure Function (NEF) 352 via a N33 interface, which may be a service-based interface. For example, the AF 360 may represent a weather network and the AF request may be a request for sensing related to air pollution. The AF request may comprise a parameter for the sensing type with an indicator value indicative of a sensing type of air pollution and a geographical area with a value or vector of values indicative of the geographical area within which to sense for air pollution. In some embodiments, the AF request may comprise a request for periodic or event-based reporting of the network-based sensing and may, in some embodiments, include an indication of periodic reporting, an indication of event-based reporting, an indication of period for reporting, an indication of an event-based trigger for reporting, or a combination thereof. In some embodiments, the AF request may comprise a one-time request for reporting and may include a start time and an end time for reporting. In many embodiments, the AF request may comprise an indication of a QoS level for reporting, wherein the QoS level may indicate a level of granularity.

The N33 interface may represent an API invoker and/or a service API in sense logic circuitry of the AF 360 and in the sense logic circuitry of the NEF 352. The N33 interface may be enhanced to support network-based sensing requests and service discovery requests related to the network-based sensing. For instance, the N33 interface may include a 5GS capability for network-based sensing comprising, e.g., sensing types supported and supported QoS levels. The sensing types may include object detection, object range estimation, object speed estimation, object angular estimation (angular direction or rotation), object tracking, object shape identification, and channel exploitation and channel resolving. The channel exploitation and channel resolving may involve extracting channel parameters as well as characteristics of the environment. The QoS levels may indicate granularities for, e.g., the object detection, object range estimation, object speed estimation, object angular estimation, object tracking, object shape identification, and channel exploitation and channel resolving, and/or the like. The N33 interface may receive and respond to AF discovery requests with information about the supported sensing types and supported QoS levels and/or to AF sensing requests with sensing reports based on sensing types and/or QoS levels identified in the AF sensing requests.

The N33 interface may support new data in the AF request including sensing type requested, geographical area, start and end time (e.g., for a one-time request rather than a continuous or ongoing request), reporting modes (e.g. periodic, event-based), frequency of reporting, and/or the like. And the N33 interface may support new data in a sensing report in response to the AF request including geographical area, sensing result (e.g., a colored 2D map indicating rainfall intensity, a colored map indicating air pollution intensity, etc.). Note that the geographical area in the sensing report may encompass the entire geographical area requested in the AF request or may comprise a portion of the geographical area requested in the AF request.

The NEF 352 may authenticate and authorize AF 360 requests such as the request for sensing with the Unified Data Repository (UDR) 210 via a N37 interface, which may be a service-based interface. The NEF 352 may authorize the request for sensing from the AF 360 via a service application program interface (API) such as a common application program interface (API) framework for 3GPP. In some embodiments, the common API framework (CAPIF) may comprise a 3GPP northbound API, which is defined in 3GPP TS 23.222. The UDR 210 may include configurations for AF 360 that define the authentication, authorization, and service discovery related to servicing the AF 360. For instance, the UDR may determine that the AF 360 is authorized to access the network-based sensing service and may define the types of information that the AF 360 is authorized to request and receive with respect to the network-based sensing.

In some embodiments, the UDR may also determine that the AF 360 is authorized for service discovery and, in response, the NEF 352 may respond to service requests from the AF 360. In some embodiments, a response to a service discovery request may include sensing types, QoS levels, and/or the like.

The CAPIF is a framework comprising common API aspects that are required to support service APIs. An API is a means by which an API invoker can access a service. A northbound API is a service API exposed to higher-layer API invokers. A service API is an interface through which a component of the system exposes its services to API invokers by abstracting or interpreting the services from the underlying mechanisms via requests and parameters. An API invoker is an entity that invokes the CAPIF or service APIs.

The NEF 352 may identify or find one or more suitable sensing service management functions (SSMFs) 218 based on information in the AF request and may relay messages between the AF 360 and the one or more SSMFs 218. For instance, the AF request may include a parameter for a geographical area such as a geographical area about a highway or a railway and the NEF 352 may determine or identify one or more SSMFs 218 that have sensing coverage that includes the geographical area about the highway or a railway and may relay or send the AF request from the AF 360 via an API to the one or more SSMFs 218 that the NEF 352 determines or identifies based on the geographical area parameter.

The one or more SSMFs 218 may receive the AF request via an API and may process or translate the AF request to map the geographical area in the AF request to a set of one or more RAN nodes 101 such as gNBs. In some embodiments, the one or more SSMFs 218 may take into account the service areas of the one or more RAN nodes 101, to limit the one or more RAN nodes 101 to RAN nodes that have service areas within or encompassing at least part of the geographical area defined by the parameter for the geographical area in the AF request.

After identifying the one or more RAN nodes 101, e.g., with a set of one or more gNB IDs, the SSMFs 218 may generate a set of sensing requests such as a sensing request for each of the one or more gNBs, and pass or send the sensing requests to the to the selected RAN nodes 101. In some embodiments, the sensing requests may include information or parameters such as a required resolution, use of specific sensing algorithms, and/or the like. In some embodiments, each of the sensing requests may include an indication of a geographical area based on the service area of the respective RAN nodes 101.

The one or more RAN nodes 101 may receive the sensing requests and may determine a sensing result in response to the sensing requests from the one or more SSMFs 218. The one or more RAN nodes 101 may perform sensing via one or more radios of the one or more RAN nodes 101. In particular, the one or more RAN nodes 101 may scan the environment in one or more directions about the one or more RAN nodes 101 by transmitting radio signal in one or more desired directions and receiving and processing the respective echoes created via reflection(s) of the radio signals off of one or more objects in the environment. In some embodiments, the one or more RAN nodes 101 may use dedicated resources for the network-based sensing functionality. In some embodiments, the one or more RAN nodes 101 may dynamically adjust an amount of dedicated resources for network-based sensing based on a number of ongoing requests as well as the corresponding resource requirements to meet sensing key performance indicators (KPIs) for each request. In some embodiments, the one or more RAN nodes 101 may determine or negotiate a granularity level or QoS level for sensing results based on one or more parameters of the sensing request, a number of network-based sensing communications, a number of other types of communications, or a combination thereof. In further embodiments, the one or more RAN nodes 101 may dynamically allocate shared resources such as physical resource blocks (PRBs) for network-based sensing.

After performing the sensing and processing the sensing data to determine sensing results (e.g., possibly based on an algorithm identified in the parameters of the sensing requests), the one or more RAN nodes 101 may deliver the sensing results to the one or more SSMFs 218. In some embodiments, the one or more RAN nodes 101 may send or pass the sensing results to the one or more SSMFs 218 via an interface such as directly through an NS2 interface (a service-based interface if available) or indirectly with a N2 interface (non-service-based interface, if available) via an access mobility function (AMF) 344. In some embodiments, the network 200 may only support either the direct interface NS2 or the indirect interface N2 and NS4 via the AMF 344 for delivery of the sensing results from a RAN 101 to an SSMF 218 as well as for delivery of the sensing request from the SSMF 218 to the RAN 101. In some embodiments, routing of the sensing request and the sensing result (directly or indirectly) may depend on the capabilities of the sense logic circuitry of the RAN node 101 and/or the SSMF 218.

For periodic sensing results, the one or more RAN nodes 101 may generate periodic sensing results as snapshots of the environment and send the periodic sensing results to the SSMF 218 periodically. For event-based sensing, in some embodiments, one or more RAN nodes 101 may process the sensing data to determine if an event occurred and only report sensing results upon detection of a trigger event. In other embodiments, for event-based sensing, one or more RAN nodes 101 may send sensing results based on snapshots of the sensing data and the SSMF 218 may process the sensing results of one or more of the snapshots of the sensing data to determine if an event occurred. In such embodiments, the SSMF 218 may determine to send a grouped response based on detection of the trigger event. For instance, for object detection related to traffic, an event may relate to detection of a static object on a highway. In such embodiments, either the RAN node 101 (or each RAN node) may process snapshots of the sensing data to detect a static object on a highway or railway or the SSMF 218 may analyze sensing results that are snapshots of the sensing data from the RAN node 101 (or each RAN node) to determine whether or not a static object exists in the sensing results.

In some embodiments, the one or more SSMFs 218 may receive or retrieve the sensing results from each of the one or more RAN nodes 101 either directly through an NS2 interface, or indirectly through the NS4 interface and the N2 interface via the AMF 344. In some embodiments, the one or more SSMFs 218 may have an optional interface NS3 with the UDR for fetching configuration data for sensing such as parameters for sensing requests.

After receiving or retrieving the sensing results from one or more of or all the one or more RAN nodes 101, the one or more SSMFs 218 may process the sensing results and send or transmit one or more grouped responses as sensing reports to the AF 360 via the NEF 352. In some embodiments, the NEF 352 may relay each grouped response from the SSMFs 218 as the grouped responses are received from the SSMFs 218. In some embodiments, the NEF 352 may collect the grouped responses from each of the one or more SSMFs 218 and send a response to the AF 360 as a sensing report that includes all the grouped responses from the one or more SSMFs 218.

In some embodiments, the one or more SSMFs 218 may reiterate sensing requests to the one or more RAN nodes 101. For instance, the one or more SSMFs 218 may determine to request more detailed information from one or more of the RAN nodes 101 after processing the sensing results and determining that additional granularity is needed to process or evaluate the sensing results from the one or more of the RAN nodes 101. As a more specific example, a specific one of the SSMFs 218 may determine that a sensing result with higher granularity or better QoS level is needed from a specific one of the RAN nodes 101 to determine if a trigger event occurred.

The AMF 344 may optionally include functionality that is used for relaying of sensing-related messages between the one or more SSMFs 218 and the one or more RAN nodes 101 in case there is no service-based interface (NS2). If there is a service-based interface (NS2) between the one or more RAN nodes 101 and the one or more SSMFs 218, the sensing-messages may be exchanged directly via the NS2 interface (i.e., via the Nran and Nssmf service-based interfaces). Note that the service-based interfaces (such as NS2, NS3, and NS4) may also or alternatively be referred to as reference points because each of the reference points NS2, NS3, and NS4 may represent more than one service-based interfaces.

The NS2 interface (reference point) between the SSMF 218 and the RAN node 101 may be a new interface to network-sensing functionality such as a RAN node capability indication, data in the sensing request from the SSMF 218 to the RAN node 101, and data in the sensing result (response to the sensing request) from the RAN node 101 to the SSMF 218. The RAN node capability indication may include, e.g., supported sensing types, QoS levels, and/or the like. For instance, the SSMF 218 may negotiate the sensing types and the QoS levels with the RAN node 101. The data in the sensing request from the SSMF 218 to the RAN node 101 may include a sensing type requested, a reporting mode requested (e.g., periodic, event-based, and/or the like), frequency of reporting, QoS level, and/or the like. The data in the sensing result from the RAN node 101 to the SSMF 218 may include detected object shape, detected object velocity, air pollution information such as particular density or intensity, rain intensity, and/or the like. The QoS levels may indicate granularities for, e.g., the detected object shape, detected object velocity, air pollution information, rain intensity, and/or the like.

In some embodiments, where messages between the SSMF 218 and the RAN node 101 are relayed or otherwise passed through the AMF 344, the sensing specific functionality discussed herein may be carried between the AMF 344 and the RAN node 101 via a next generation application protocol (NGAP), which is specified in 3GPP TS 38.413, in an appropriate container. The NGAP includes features such as mobility management, session management, connection management, security, and QoS management. It utilizes protocols such as the user datagram protocol (UDP) or the stream control transmission protocol (SCTP) for the transport of user plane data.

The NGAP control plane handles the signaling messages exchanged between the AMF and the RAN 101. These messages are used for various purposes, including mobility management, session management, and connection management.

FIG. 2B illustrates an embodiment of a network 250 in accordance with various embodiments such as the network 100 in FIG. 1. The network 250 may be a service-based interconnect (SBI) representation of a cellular network such as a 5GS, a 6GS network, or a later generation network. The network 250 includes the same NFs related to network-based sensing as is depicted in FIG. 2A but in an SBI representation. The service-based interfaces are labeled as N followed by the lowercase acronym for the underlying service producer and are connected to a main bus that represents the ability for any authorized NF to access the service of another NF directly.

In the network 250, the SBI for the NEF 352 is labeled Nnef, UDR 210 is labeled Nudr, AF 360 is labeled Naf, AMF 344 is labeled Namf, RAN node 101 is labeled Nran, and SSMF 218 is labeled Nssmf. The RAN node 101 is connected with the AMF 344 via a dashed line to indicate the optional implementation of a non-service-based interface for embodiments in which the SSMF 218 may relay messages such as the sensing request through the AMF 344 via the Nssmf interface, the Namf interface, and the N2 interface to the RAN node 101. In such embodiments, the RAN node 101 may relay messages such as the sensing result via the N2 interface, the Namf interface, and the Nssmf interface via the AMF 344 to the SSMF 218.

In other embodiments, the SSMF 218 may send or deliver messages directly to the RAN node 101 via the Nssmf interface and the Nran interface, and the RAN node 101 may send or deliver messages directly to the SSMF 218 via the Namf interface and the Nssmf interface. For instance, the AF 360 may represent a traffic network and may send an AF request to the NEF 352 for network-based sensing related to traffic along with the geographical area within which to sense the traffic. The NEF 352 may verify authorization for the request via the UDR 210 and process the AF request to identify the SSMF 218 as the SSMF associated with network-based sensing for the geographical area identified in the AF request. In other embodiments, the geographical area in the AF request may overlap the geographical areas of more than one SSMFs.

After identifying the SSMF 218, the NEF 352 may send or deliver the AF request to the SSMF 218 (or to the more than one SSMF). The SSMF 218 may receive and parse the AF request to determine parameters in the AF request such as the sensing type, the geographical area, a response time, a QoS level, start and end time, a reporting mode (such as periodic, event-based, etc. and/or a combination thereof), frequency of reporting, etc., or a combination thereof.

The SSMF 218 may process the AF request to identify base stations or RAN nodes such as RAN node 101 that have service areas that overlap with the geographical area identified in the AF request and may send or transmit sensing requests to the base stations or RAN nodes such as RAN node 101 via the Nssmf interface and the Nran interface. In other embodiments, the SSMF 218 may send or transmit the sensing request to the base stations or RAN nodes such as RAN node 101 via the Nssmf interface, the Namf interface, and the N2 interface via the AMF 344.

The base stations or RAN nodes such as RAN node 101 may receive the sensing request, parse the sensing request to determine the parameters associated with the network-based sensing, and perform the network-based sensing to determine a sensing result. After determining the sensing result, the base stations or RAN nodes such as RAN node 101 may transmit or send the sensing result to the SSMF 218 via the Nran interface and the Nssmf interface. In other embodiments, the base stations or RAN nodes such as RAN node 101 may transmit or send the sensing result to the SSMF 218 via the N2 interface, the AMF 344, the Namf interface, and the Nssmf interface.

The SSMF 218 may receive the sensing results from the base stations or RAN nodes such as RAN node 101, process the sensing results, and deliver a grouped response to the AF 360. For instance, if the sensing type is rainfall or rainfall intensity, the SSMF 218 may process and group the sensing results from the base stations or RAN nodes such as RAN node 101 to generate a map of the rainfall or rainfall intensity in the geographical area identified in the AF request. The SSMF 218 may then deliver or send the map of the rainfall or rainfall intensity in the geographical area in a sensing report to the AF 360 via the NEF 352 through the Nssmf interface, the Nnef interface, and the Naf interface. In some embodiments, for periodic or event-based sensing types, the SSMF 218 may provide a complete map of the rainfall or rainfall intensity in each grouped response sent to the AF 360. In some embodiments, for periodic or event-based sensing types, the SSMF 218 may provide a complete map of the rainfall or rainfall intensity in a first grouped response to the AF 360 and may provide updates to the complete map in subsequent grouped responses to the AF 360. In further embodiments, the SSMF 218 may send a complete map of the rainfall or rainfall intensity periodically to the AF 360 and send periodic or event-based updates for the complete map between transmissions of the complete map to the AF 360.

FIG. 3 illustrates an embodiment of a network 300 in accordance with various embodiments such as the network 100 in FIG. 1. The network 300 may operate in a manner consistent with 3GPP technical specifications for LTE or 5G/NR systems However, the example embodiments are not limited in this regard and the described embodiments may apply to other networks that benefit from the principles described herein, such as future 3GPP systems, or the like.

The network 300 may include a UE 302B, which may include any mobile or non-mobile computing device designed to communicate with a RAN 304 via an over-the-air connection. The UE 302B may be communicatively coupled with the RAN 304 by a Uu interface. The UE 302B may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, machine-to-machine (M2M) or device-to-device (D2D) device, IoT device, etc.

In some embodiments, the network 300 may include a plurality of UEs coupled directly with one another via a sidelink interface. The UEs may be M2M/D2D devices that communicate using physical sidelink channels such as, but not limited to, Physical Sidelink Broadcast Channel (PSBCH), Physical Sidelink Downlink Channel (PSDCH), Physical Sidelink Shared Channel (PSSCH), Physical Sidelink Control Channel (PSCCH), Physical Sidelink Feedback Channel (PSFCH), etc.

In some embodiments, the UE 302B may additionally communicate with an access point (AP) 306 via an over-the-air connection. The AP 306 may manage a wireless local area network (WLAN) connection, which may serve to offload some/all network traffic from the RAN 304. The connection between the UE 302B and the AP 306 may be consistent with any IEEE 802.11 protocol, wherein the AP 306 could be a wireless fidelity (Wi-Fi®) router. In some embodiments, the UE 302B, RAN 304, and AP 306 may utilize cellular-WLAN aggregation (for example, LTE-WLAN aggregation/LTE/WLAN Radio Level Integration with Internet Protocol Security (IPsec) Tunnel (LWA/LWIP). Cellular-WLAN aggregation may involve the UE 302B being configured by the RAN 304 to utilize both cellular radio resources and WLAN resources.

The RAN 304 may include one or more access nodes, for example, AN 308. AN 308 may terminate air-interface protocols for the UE 302B by providing access stratum protocols including radio resource control (RRC), Packet Data Convergence Protocol (PDCP), radio link control (RLC), medium access control (MAC), and layer 1 (L1) (physical layer) protocols. In this manner, the AN 308 may enable data/voice connectivity between CN 320 and the UE 302B. In some embodiments, the AN 308 may be implemented in a discrete device or as one or more software entities running on server computers as part of, for example, a virtual network, which may be referred to as a Cloud Radio Access Network (CRAN) or virtual baseband unit pool. The AN 308 be referred to as a base station (BS), next generation NodeB (gNB), RAN node, evolved NodeB (eNB), next generation evolved NodeB (ng-eNB), NodeB, road-side unit (RSU), Transmission Reception Point (TRxP), Transmission Reception Point (TRP), etc. The AN 308 may be a macrocell base station or a low power base station for providing femtocells, picocells or other like cells having smaller coverage areas, smaller user capacity, or higher bandwidth compared to macrocells.

In embodiments in which the RAN 304 includes a plurality of ANs, they may be coupled with one another via an X2 interface (if the RAN 104 is an LTE RAN) or an Xn interface (if the RAN 304 is a 5G RAN). The X2/Xn interfaces, which may be separated into control/user plane interfaces in some embodiments, may allow the ANs to communicate information related to handovers, data/context transfers, mobility, load management, interference coordination, etc.

The ANs of the RAN 304 may each manage one or more cells, cell groups, component carriers, etc. to provide the UE 302B with an air interface for network access. The UE 302B may be simultaneously connected with a plurality of cells provided by the same or different ANs of the RAN 304. For example, the UE 302B and RAN 104 may use carrier aggregation to allow the UE 302B to connect with a plurality of component carriers, each corresponding to a primary cell (Pcell) or secondary cell (Scell). In dual connectivity scenarios, a first AN may be a master node that provides an master cell group (MCG) and a second AN may be secondary node that provides an Secondary Cell Group (SCG). The first/second ANs may be any combination of eNB, gNB, ng-eNB, etc.

The RAN 304 may provide the air interface over a licensed spectrum or an unlicensed spectrum. To operate in the unlicensed spectrum, the nodes may use Licensed Assisted Access (LAA), enhanced Licensed Assisted Access (eLAA), and/or further enhanced Licensed Assisted Access (feLAA) mechanisms based on Carrier Aggregation (CA) technology with PCells/Scells. Prior to accessing the unlicensed spectrum, the nodes may perform medium/carrier-sensing operations based on, for example, a listen-before-talk (LBT) protocol.

In vehicle-to-everything (V2X) scenarios the UE 302B or AN 308 may be or act as an road-side unit (RSU), which may refer to any transportation infrastructure entity used for V2X communications. An RSU may be implemented in or by a suitable AN or a stationary (or relatively stationary) UE. An RSU implemented in or by: a UE may be referred to as a “UE-type RSU”; an eNB may be referred to as an “eNB-type RSU”; a gNB may be referred to as a “gNB-type RSU”; and the like. In one example, an RSU is a computing device coupled with radio frequency circuitry located on a roadside that provides connectivity support to passing vehicle UEs. The RSU may also include internal data storage circuitry to store intersection map geometry, traffic statistics, media, as well as applications/software to sense and control ongoing vehicular and pedestrian traffic. The RSU may provide very low latency communications required for high-speed events, such as crash avoidance, traffic warnings, and the like. Additionally or alternatively, the RSU may provide other cellular/WLAN communications services. The components of the RSU may be packaged in a weatherproof enclosure suitable for outdoor installation, and may include a network interface controller to provide a wired connection (e.g., Ethernet) to a traffic signal controller or a backhaul network.

In some embodiments, the RAN 304 may be an LTE RAN 310 with eNBs, for example, eNB 312. The LTE RAN 310 may provide an LTE air interface with the following characteristics: Subcarrier Spacing (SCS) of 15 kHz; control plane orthogonal frequency division multiplexing (CP-OFDM) waveform for downlink (DL) and single carrier frequency division multiple access (SC-FDMA) waveform for uplink (UL); turbo codes for data and Tail-Biting Convolutional Code (TBCC) for control; etc. The LTE air interface may rely on Channel-State Information reference signal (CSI-RS) for Channel-State Information (CSI) acquisition and beam management; physical downlink shared channel/physical downlink control channel demodulation reference signal (PDSCH/PDCCH DMRS) for PDSCH/PDCCH demodulation; and cell-specific reference signal (CRS) for cell search and initial acquisition, channel quality measurements, and channel estimation for coherent demodulation/detection at the UE. The LTE air interface may operate on sub-6 GHZ bands.

In some embodiments, the RAN 304 may be an NG-RAN 314 with gNBs, for example, gNB 316, or ng-eNBs, for example, ng-eNB 318. The gNB 316 may connect with 5G-enabled UEs using a 5G NR interface. The gNB 316 may connect with a 5G core through an NG interface, which may include an N2 interface or an N3 interface. The ng-eNB 318 may also connect with the 5G core through an NG interface, but may connect with a UE via an LTE air interface. The gNB 316 and the ng-eNB 318 may connect with each other over an Xn interface.

In some embodiments, the NG interface may be split into two parts, an NG user plane (NG-U) interface, which carries traffic data between the nodes of the NG-RAN 314 and a user plane function (UPF) 348 (e.g., N3 interface), and an NG control plane (NG-C) interface, which is a signaling interface between the nodes of the NG-RAN 314 and an AMF 344 (e.g., N2 interface).

The NG-RAN 314 may provide a 5G-NR air interface with the following characteristics: variable SCS; CP-OFDM for DL, CP-OFDM and Discrete Fourier Transform-Spread-Orthogonal Frequency Division Multiplexing (DFT-s-OFDM) for UL; polar, repetition, simplex, and Reed-Muller codes for control and Low-density parity-check (LDPC) for data. The 5G-NR air interface may rely on CSI-RS, PDSCH/PDCCH DMRS similar to the LTE air interface. The 5G-NR air interface may not use a CRS, but may use PBCH DMRS for PBCH demodulation; Phase-tracking reference signal (PTRS) for phase tracking for PDSCH; and tracking reference signal for time tracking. The 5G-NR air interface may operate on FR1 bands that include sub-6 GHz bands or FR2 bands that include bands from 24.25 GHz to 52.6 GHz. The 5G-NR air interface may include a Synchronization Signal Block (SSB) that is an area of a downlink resource grid that includes primary synchronization signal/secondary synchronization signal/physical broadcast channel (PSS/SSS/PBCH).

In some embodiments, the 5G-NR air interface may utilize bandwidth parts (BWPs) for various purposes. For example, BWP can be used for dynamic adaptation of the SCS. For example, the UE 302B can be configured with multiple BWPs where each BWP configuration has a different SCS. When a BWP change is indicated to the UE 302B, the SCS of the transmission is changed as well. Another use case example of BWP is related to power saving. In particular, multiple BWPs can be configured for the UE 302B with different amount of frequency resources (for example, physical resource blocks (PRBs)) to support data transmission under different traffic loading scenarios. A BWP containing a smaller number of PRBs can be used for data transmission with small traffic load while allowing power saving at the UE 302B and in some cases at the gNB 316. A BWP containing a larger number of PRBs can be used for scenarios with higher traffic load.

The RAN 304 is communicatively coupled to core network (CN) 320 that includes network elements to provide various functions to support data and telecommunications services to customers/subscribers (for example, users of UE 302B). The components of the CN 320 may be implemented in one physical node or separate physical nodes. In some embodiments, Network Functions Virtualization (NFV) may be utilized to virtualize any of or all the functions provided by the network elements of the CN 320 onto physical compute/storage resources in servers, switches, etc. A logical instantiation of the CN 320 may be referred to as a network slice, and a logical instantiation of a portion of the CN 320 may be referred to as a network sub-slice.

In some embodiments, the CN 320 may be an LTE CN 322, which may also be referred to as an Evolved Packet Core (EPC). The LTE CN 322 may include Mobility Management Entity (MME) 324, Serving Gateway (SGW) 326, Serving General Packet Radio Service (GPRS) Support Node (SGSN) 328, Home Subscriber Server (HSS) 330, Packet Data Network (PDN) Gateway (PGW) 332, and Policy Control and Charging Rules Function (PCRF) 334 coupled with one another over interfaces (or “reference points”) as shown. Functions of the elements of the LTE CN 322 may be briefly introduced as follows.

The MME 324 may implement mobility management functions to track a current location of the UE 302B to facilitate paging, bearer activation/deactivation, handovers, gateway selection, authentication, etc.

The SGW 326 may terminate an S1 interface toward the RAN and route data packets between the RAN and the LTE CN 322. The SGW 326 may be a local mobility anchor point for inter-RAN node handovers and also may provide an anchor for inter-3GPP mobility. Other responsibilities may include lawful intercept, charging, and some policy enforcement.

The SGSN 328 may track a location of the UE 302B and perform security functions and access control. In addition, the SGSN 328 may perform inter-EPC node signaling for mobility between different RAT networks; PDN and S-GW selection as specified by MME 324; MME selection for handovers; etc. The S3 reference point between the MME 324 and the SGSN 328 may enable user and bearer information exchange for inter-3GPP access network mobility in idle/active states.

The HSS 330 may include a database for network users, including subscription-related information to support the network entities' handling of communication sessions. The HSS 330 can provide support for routing/roaming, authentication, authorization, naming/addressing resolution, location dependencies, etc. An S6a reference point between the HSS 330 and the MME 324 may enable transfer of subscription and authentication data for authenticating/authorizing user access to the LTE CN 322.

The PGW 332 may terminate an SGi interface toward a data network (DN) 336 that may include an application/content server 338. The PGW 132 may route data packets between the LTE CN 322 and the data network 336. The PGW 132 may be coupled with the SGW 326 by an S5 reference point to facilitate user plane tunneling and tunnel management. The PGW 332 may further include a node for policy enforcement and charging data collection (for example, Policy and Charging Enforcement Function (PCEF)). Additionally, the SGi reference point between the PGW 332 and the data network 336 may be an operator external public, a private PDN, or an intra-operator packet data network, for example, for provision of IP Multimedia Subsystem (IMS) services. The PGW 332 may be coupled with a PCRF 334 via a Gx reference point.

The PCRF 334 is the policy and charging control element of the LTE CN 322. The PCRF 334 may be communicatively coupled to the app/content server 338 to determine appropriate quality-of-service (QoS) and charging parameters for service flows. The PCRF 332 may provision associated rules into a PCEF (via Gx reference point) with appropriate Traffic Flow Template (TFT) and QoS class of identifier (QCI).

In some embodiments, the CN 320 may be a 5GC 340. The 5GC 340 may include an Authentication Server Function (AUSF) 342, AMF 344, Session Management Function (SMF) 346, UPF 348, Network Slice Selection Function (NSSF) 350, NEF 352, Network Function Repository Function (NRF) 354, Policy Control Function (PCF) 356, Unified Data Management (UDM) 358, AF 360, UDR 210, and SSMF 218 coupled with one another over interfaces (or “reference points”) as shown. Functions of the elements of the 5GC 340 may be briefly introduced as follows.

The AUSF 342 may store data for authentication of UE 302B and handle authentication-related functionality. The AUSF 342 may facilitate a common authentication framework for various access types. In addition to communicating with other elements of the 5GC 340 over reference points as shown, the AUSF 342 may exhibit an Nausf service-based interface.

The AMF 344 may allow other functions of the 5GC 340 to communicate with the UE 302B and the RAN 304 and to subscribe to notifications about mobility events with respect to the UE 302B. The AMF 344 may be responsible for registration management (for example, for registering UE 302B), connection management, reachability management, mobility management, lawful interception of AMF-related events, and access authentication and authorization. The AMF 344 may provide transport for SM messages between the UE 302B and the SMF 346, and act as a transparent proxy for routing SM messages. AMF 344 may also provide transport for SMS messages between UE 302B and a short message service function (SMSF). AMF 344 may interact with the AUSF 342 and the UE 302B to perform various security anchor and context management functions. Furthermore, AMF 344 may be a termination point of a RAN control plane (CP) interface, which may include or be an N2 reference point between the RAN 304 and the AMF 344; and the AMF 344 may be a termination point of Non-Access Stratum (NAS) (N1) signaling, and perform NAS ciphering and integrity protection. AMF 344 may also support NAS signaling with the UE 302B over an N3 IWF interface.

The SMF 346 may be responsible for SM (for example, session establishment, tunnel management between User Plane Function (UPF) 348 and AN 308); UE IP address allocation and management (including optional authorization); selection and control of user plane (UP) function; configuring traffic steering at UPF 348 to route traffic to proper destination; termination of interfaces toward policy control functions; controlling part of policy enforcement, charging, and QoS; lawful intercept (for SM events and interface to LI system); termination of Session Management (SM) parts of Non-Access Stratum (NAS) messages; downlink data notification; initiating AN specific SM information, sent via AMF 344 over N2 to AN 308; and determining SSC mode of a session. SM may refer to management of a PDU session, and a PDU session or “session” may refer to a Protocol Data Unit (PDU) connectivity service that provides or enables the exchange of PDUs between the UE 102B and the data network 336.

The UPF 348 may act as an anchor point for intra-RAT and inter-RAT mobility, an external PDU session point of interconnect to data network 336, and a branching point to support multi-homed PDU session. The UPF 348 may also perform packet routing and forwarding, perform packet inspection, enforce the user plane part of policy rules, lawfully intercept packets (UP collection), perform traffic usage reporting, perform QoS handling for a user plane (e.g., packet filtering, gating, UL/DL rate enforcement), perform uplink traffic verification (e.g., Service Data Flow-to-QoS (SDF-to-QoS) flow mapping), transport level packet marking in the uplink and downlink, and perform downlink packet buffering and downlink data notification triggering. UPF 348 may include an uplink classifier to support routing traffic flows to a data network.

The Network Slice Selection Function (NSSF) 350 may select a set of network slice instances serving the UE 302B. The NSSF 350 may also determine allowed Network Slice Selection Assistance Information (NSSAI) and the mapping to the subscribed Single-Network Slice Selection Assistance Informations (S-NSSAIs), if needed. The NSSF 350 may also determine the AMF set to be used to serve the UE 302B, or a list of candidate AMFs based on a suitable configuration and possibly by querying the NRF 354. The selection of a set of network slice instances for the UE 302B may be triggered by the AMF 344 with which the UE 302B is registered by interacting with the NSSF 350, which may lead to a change of AMF. The NSSF 350 may interact with the AMF 344 via an N22 reference point; and may communicate with another NSSF in a visited network via an N31 reference point (not shown). Additionally, the NSSF 350 may exhibit an Nnssf service-based interface.

The NEF 352 may securely expose services and capabilities provided by 3GPP network functions for third party, internal exposure/re-exposure, application functions (AFs) (c.g., AF 360), edge computing or fog computing systems, etc. In such embodiments, the NEF 352 may authenticate, authorize, or throttle the AFs. NEF 352 may also translate information exchanged with the AF 360 and information exchanged with internal network functions. For example, the NEF 352 may translate between an AF-Service-Identifier and an internal 5GC information. NEF 352 may also receive information from other NFs based on exposed capabilities of other NFs. This information may be stored at the NEF 352 as structured data, or at a data storage NF using standardized interfaces. The stored information can then be re-exposed by the NEF 352 to other NFs and AFs, or used for other purposes such as analytics. Additionally, the NEF 352 may exhibit an Nnef service-based interface.

The NRF 354 may support service discovery functions, receive NF discovery requests from NF instances, and provide the information of the discovered NF instances to the NF instances. NRF 354 also maintains information of available NF instances and their supported services. As used herein, the terms “instantiate,” “instantiation,” and the like may refer to the creation of an instance, and an “instance” may refer to a concrete occurrence of an object, which may occur, for example, during execution of program code. Additionally, the NRF 354 may exhibit the Nnrf service-based interface.

The PCF 356 may provide policy rules to control plane functions to enforce them, and may also support unified policy framework to govern network behavior. The PCF 356 may also implement a front end to access subscription information relevant for policy decisions in a UDR of the Unified Data Management (UDM) 358. In addition to communicating with functions over reference points as shown, the PCF 356 exhibit an Npcf service-based interface.

The UDM 358 may handle subscription-related information to support the network entities' handling of communication sessions, and may store subscription data of UE 302B. For example, subscription data may be communicated via an N8 reference point between the UDM 358 and the AMF 344. The UDM 358 may include two parts, an application front end and a UDR. The UDR may store subscription data and policy data for the UDM 358 and the PCF 356, and/or structured data for exposure and application data (including PFDs for application detection, application request information for multiple UEs 302B) for the NEF 352. The Nudr service-based interface may be exhibited by the UDR 210 to allow the UDM 358, PCF 356, and NEF 352 to access a particular set of the stored data, as well as to read, update (e.g., add, modify), delete, and subscribe to notification of relevant data changes in the UDR. The UDM may include a UDM front end (UDM-FE), which is in charge of processing credentials, location management, subscription management and so on. Several different front ends may serve the same user in different transactions. The UDM-FE accesses subscription information stored in the UDR and performs authentication credential processing, user identification handling, access authorization, registration/mobility management, and subscription management. In addition to communicating with other NFs over reference points as shown, the UDM 358 may exhibit the Nudm service-based interface.

The AF 360 may provide application influence on traffic routing, provide access to NEF, and interact with the policy framework for policy control.

In some embodiments, the 5GC 340 may enable edge computing by selecting operator/3rd party services to be geographically close to a point that the UE 302B is attached to the network. This may reduce latency and load on the network. To provide edge-computing implementations, the 5GC 340 may select a UPF 348 close to the UE 302B and execute traffic steering from the UPF 348 to data network 336 via the N6 interface. This may be based on the UE subscription data, UE location, and information provided by the AF 360. In this way, the AF 360 may influence UPF (re)selection and traffic routing. Based on operator deployment, when AF 360 is considered to be a trusted entity, the network operator may permit AF 360 to interact directly with relevant NFs. Additionally, the AF 360 may exhibit a Naf service-based interface.

The data network 336 may represent various network operator services, Internet access, or third-party services that may be provided by one or more servers including, for example, application/content server 338.

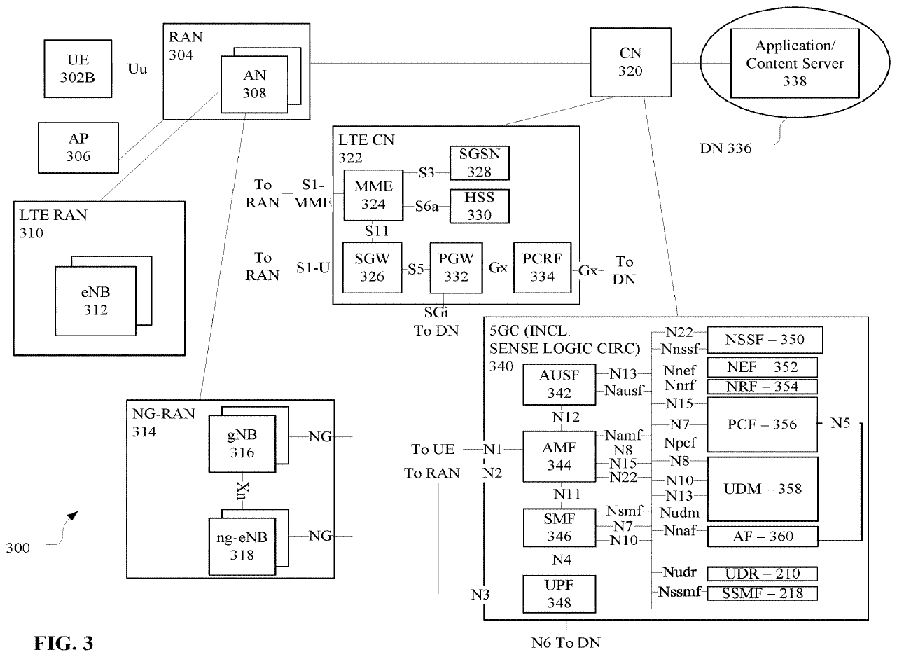

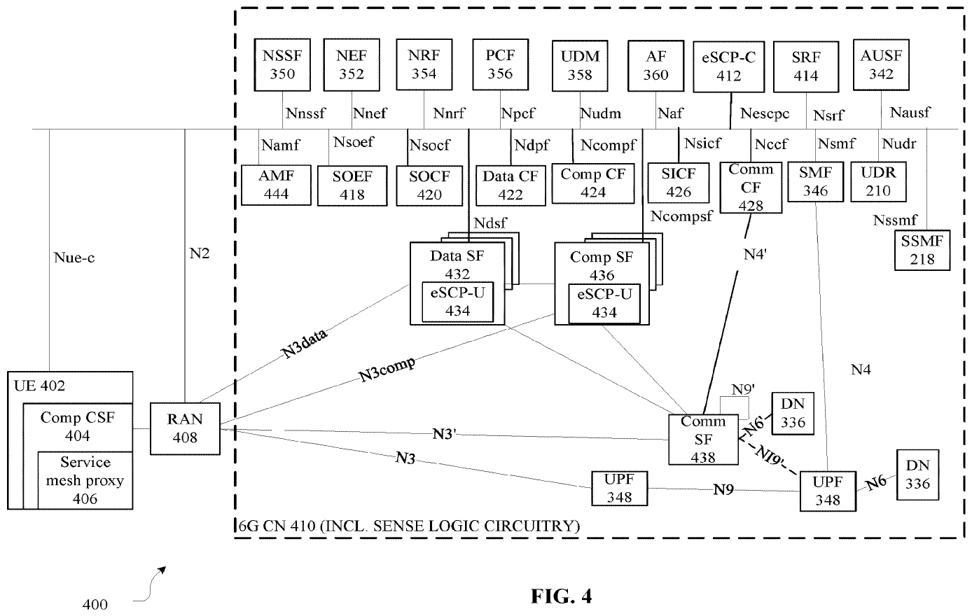

FIG. 4 illustrates an embodiment of a network 400 in accordance with various embodiments. The network 400 may operate in a matter consistent with 3GPP technical specifications or technical reports for 6G systems. In some embodiments, the network 400 may operate concurrently with network 300. For example, in some embodiments, the network 400 may share one or more frequency or bandwidth resources with network 300. As one specific example, a UE (e.g., UE 402) may be configured to operate in both network 400 and network 300. Such configuration may be based on a UE including circuitry configured for communication with frequency and bandwidth resources of both networks 300 and 400. In general, several elements of network 400 may share one or more characteristics with elements of network 300. For the sake of brevity and clarity, such elements may not be repeated in the description of network 400.

The network 400 may include a UE 402, which may include any mobile or non-mobile computing device designed to communicate with a RAN 408 via an over-the-air connection. The UE 402 may be similar to, for example, UE 302B. The UE 402 may be, but is not limited to, a smartphone, tablet computer, wearable computer device, desktop computer, laptop computer, in-vehicle infotainment, in-car entertainment device, instrument cluster, head-up display device, onboard diagnostic device, dashtop mobile equipment, mobile data terminal, electronic engine management system, electronic/engine control unit, electronic/engine control module, embedded system, sensor, microcontroller, control module, engine management system, networked appliance, machine-type communication device, M2M or D2D device, IoT device, etc.

Although not specifically shown in FIG. 4, in some embodiments the network 400 may include a plurality of UEs coupled directly with one another via a sidelink interface. The UEs may be M2M/D2D devices that communicate using physical sidelink channels such as, but not limited to, PSBCH, PSDCH, PSSCH, PSCCH, PSFCH, etc. Similarly, although not specifically shown in FIG. 4, the UE 402 may be communicatively coupled with an AP such as AP 306 as described with respect to FIG. 3. Additionally, although not specifically shown in FIG. 4, in some embodiments the RAN 408 may include one or more ANs such as AN 308 as described with respect to FIG. 3. The RAN 408 and/or the AN of the RAN 408 may be referred to as a base station (BS), a RAN node, or using some other term or name.

The UE 402 and the RAN 408 may be configured to communicate via an air interface that may be referred to as a sixth generation (6G) air interface. The 6G air interface may include one or more features such as communication in a terahertz (THz) or sub-THz bandwidth, or joint communication and sensing. As used herein, the term “joint communication and sensing” may refer to a system that allows for wireless communication as well as radar-based sensing via various types of multiplexing. As used herein, THz or sub-THz bandwidths may refer to communication in the 80 GHz and above frequency ranges. Such frequency ranges may additionally or alternatively be referred to as “millimeter wave” or “mmWave” frequency ranges.

The RAN 408 may allow for communication between the UE 402 and a 6G core network (CN) 410. Specifically, the RAN 408 may facilitate the transmission and reception of data between the UE 402 and the 6G CN 410. The 6G CN 410 may include various functions such as NSSF 350, NEF 352, NRF 354, PCF 356, UDM 358, AF 360, UDR 210, SSMF 218, SMF 346, and AUSF 342. The 6G CN 410 may additional include UPF 348 and DN 336 as shown in FIG. 3.

Additionally, the RAN 408 may include various additional functions that are in addition to, or alternative to, functions of a legacy cellular network such as a 4G or 5G network. Two such functions may include a Compute Control Function (Comp CF) 424 and a Compute Service Function (Comp SF) 436. The Comp CF 424 and the Comp SF 436 may be parts or functions of the Computing Service Plane. Comp CF 424 may be a control plane function that provides functionalities such as management of the Comp SF 436, computing task context generation and management (e.g., create, read, modify, delete), interaction with the underlaying computing infrastructure for computing resource management, etc. Comp SF 436 may be a user plane function that serves as the gateway to interface computing service users (such as UE 402) and computing nodes behind a Comp SF instance. Some functionalities of the Comp SF 436 may include: parse computing service data received from users to compute tasks executable by computing nodes; hold service mesh ingress gateway or service API gateway; service and charging policies enforcement; performance monitoring and telemetry collection, etc. In some embodiments, a Comp SF 436 instance may serve as the user plane gateway for a cluster of computing nodes. A Comp CF 424 instance may control one or more Comp SF 436 instances.

Two other such functions may include a Communication Control Function (Comm CF) 428 and a Communication Service Function (Comm SF) 438, which may be parts of the Communication Service Plane. The Comm CF 428 may be the control plane function for managing the Comm SF 438, communication sessions creation/configuration/releasing, and managing communication session context. The Comm SF 438 may be a user plane function for data transport. Comm CF 428 and Comm SF 438 may be considered as upgrades of SMF 346 and UPF 348, which were described with respect to a 5G system in FIG. 3. The upgrades provided by the Comm CF 428 and the Comm SF 438 may enable service-aware transport. For legacy (e.g., 4G or 5G) data transport, SMF 346 and UPF 348 may still be used.

Two other such functions may include a Data Control Function (Data CF) 422 and Data Service Function (Data SF) 432 may be parts of the Data Service Plane. Data CF 422 may be a control plane function and provides functionalities such as Data SF 3032 management, Data service creation/configuration/releasing, Data service context management, etc. Data SF 432 may be a user plane function and serve as the gateway between data service users (such as UE 402 and the various functions of the 6G CN 410) and data service endpoints behind the gateway. Specific functionalities may include parse data service user data and forward to corresponding data service endpoints, generate charging data, and report data service status.

Another such function may be the Service Orchestration and Chaining Function (SOCF) 420, which may discover, orchestrate and chain up communication/computing/data services provided by functions in the network. Upon receiving service requests from users, SOCF 420 may interact with one or more of Comp CF 424, Comm CF 428, and Data CF 422 to identify Comp SF 436, Comm SF 438, and Data SF 432 instances, configure service resources, and generate the service chain, which could contain multiple Comp SF 436, Comm SF 438, and Data SF 432 instances and their associated computing endpoints. Workload processing and data movement may then be conducted within the generated service chain. The SOCF 420 may also be responsible for maintaining, updating, and releasing a created service chain.

Another such function may be the service registration function (SRF) 414, which may act as a registry for system services provided in the user plane such as services provided by service endpoints behind Comp SF 436 and Data SF 432 gateways and services provided by the UE 402. The SRF 414 may be considered a counterpart of NRF 354, which may act as the registry for network functions.

Other such functions may include an evolved service communication proxy (eSCP) and service infrastructure control function (SICF) 426, which may provide service communication infrastructure for control plane services and user plane services. The eSCP may be related to the service communication proxy (SCP) of 5G with user plane service communication proxy capabilities being added. The eSCP is therefore expressed in two parts: eCSP-C 412 and eSCP-U 434, for control plane service communication proxy and user plane service communication proxy, respectively. The SICF 426 may control and configure eCSP instances in terms of service traffic routing policies, access rules, load balancing configurations, performance monitoring, etc.

Another such function is the AMF 444. The AMF 444 may be similar to 344, but with additional functionality. Specifically, the AMF 444 may include potential functional repartition, such as move the message forwarding functionality from the AMF 444 to the RAN 408.

Another such function is the service orchestration exposure function (SOEF) 418. The SOEF may be configured to expose service orchestration and chaining services to external users such as applications.

The UE 402 may include an additional function that is referred to as a computing client service function (comp CSF) 404. The comp CSF 404 may have both the control plane functionalities and user plane functionalities, and may interact with corresponding network side functions such as SOCF 420, Comp CF 424, Comp SF 436, Data CF 422, and/or Data SF 432 for service discovery, request/response, compute task workload exchange, etc. The Comp CSF 404 may also work with network side functions to decide on whether a computing task should be run on the UE 402, the RAN 408, and/or an element of the 6G CN 410.

The UE 402 and/or the Comp CSF 404 may include a service mesh proxy 406. The service mesh proxy 406 may act as a proxy for service-to-service communication in the user plane. Capabilities of the service mesh proxy 406 may include one or more of addressing, security, load balancing, etc.

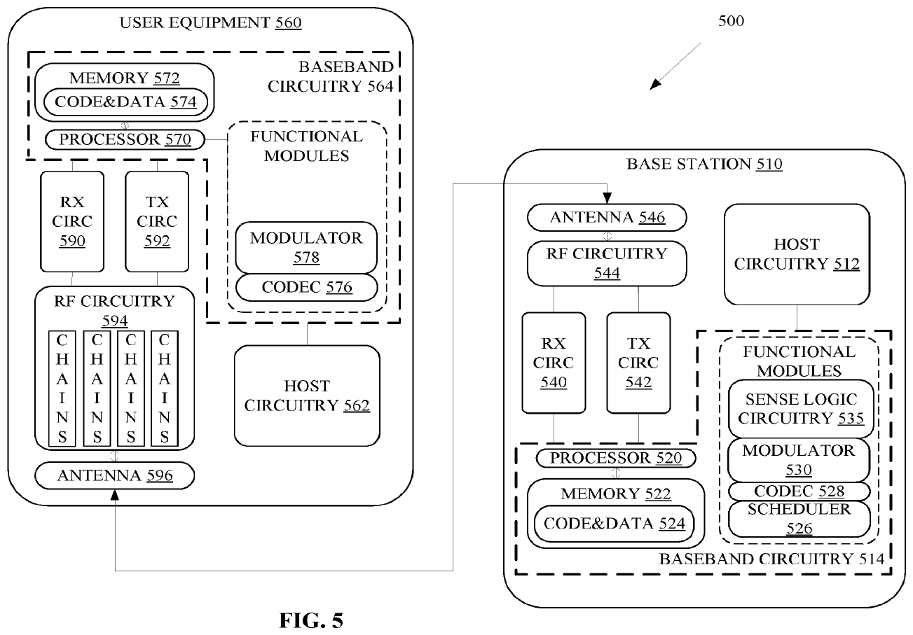

FIG. 5 is an embodiment of a simplified block diagram 500 of a base station 501 and a user equipment (UE) 511 that may carry out certain embodiments in a communication network such as the base stations or RANs and communication networks shown in FIGS. 1, 2A-2B, 3, and 4. For the base station 510, the antenna 546 transmits and receives radio signals. The RF circuitry 544 coupled with the antenna 546, which is the physical layer of the base station 510, receives RF signals from the antenna 546 and performs operations on the signals such as amplifying signals, and splitting the signals into quadrature phase and in-phase signals. The receiver circuitry 590 may convert the signals to digital baseband signals, or uplink data, and pass the digital in-phase and quadrature phase signals to the processor 520 of the baseband circuitry 514, also referred to as the processing circuitry or baseband processing circuitry, via an interface of the baseband circuitry 514. In other embodiments, analog to digital converters of the processor 520 may convert the in-phase and quadrature phase signals to digital baseband signals.

The transmitter circuitry 592 may convert received, digital baseband signals, or downlink data, from the processor 520 to analog signals. The RF circuitry 544 processes and amplifies the analog signals and converts the analog signals to RF signals and passes the amplified, analog RF signals out to antenna 546.

The processor 520 decodes and processes the digital baseband signals, or uplink data, and invokes different functional modules to perform features in the base station 510. The memory 522 stores program instructions or code and data 524 to control the operations of the base station 510. The host circuitry 512 may execute code such as RRC layer code from the code and data 524 to implement RRC layer functionality and code.

A similar configuration exists in UE 560 where the antenna 596 transmits and receives RF signals. The RF circuitry 594, coupled with the antenna 596, receives RF signals from the antenna 596, amplifies the RF signals, and processes the signals to generate analog in-phase and quadrature phase signals. The receiver circuitry 590 processes and converts the analog in-phase and quadrature phase signals to digital baseband signals via an analog to digital converter, or downlink data, and passes the in-phase and quadrature phase signals to processor 570 of the baseband circuitry 564 via an interface of the baseband circuitry 564. In other embodiments, the processor 570 may comprise analog to digital converters to convert the analog in-phase and quadrature phase signals to digital in-phase and quadrature phase signals.

The transmitter circuitry 592 may convert received, digital baseband signals, or downlink data, from the processor 570 to analog signals. The RF circuitry 594 processes and amplifies the analog signals and converts the analog signals to RF signals and passes the amplified, analog RF signals out to antenna 596.

The RF circuitry 594 illustrates multiple RF chains. While the RF circuitry 594 illustrates five RF chains, each UE may have a different number of RF chains and each of the RF chains in the illustration may represent multiple, time domain, receive (RX) chains and transmit (TX) chains. The RX chains and TX chains include circuitry that may operate on or modify the time domain signals transmitted through the time domain chains such as circuitry to insert guard intervals in the TX chains and circuitry to remove guard intervals in the RX chains. For instance, the RF circuitry 594 may include transmitter circuitry and receiver circuitry, which is often called transceiver circuitry. The transmitter circuitry may prepare digital data from the processor 570 for transmission through the antenna 596. In preparation for transmission, the transmitter may encode the data, and modulate the encoded data, and form the modulated, encoded data into Orthogonal Frequency Division Multiplex (OFDM) and/or Orthogonal Frequency Division Multiple Access (OFDMA) symbols. Thereafter, the transmitter may convert the symbols from the frequency domain into the time domain for input into the TX chains. The TX chains may include a chain per subcarrier of the bandwidth of the RF chain and may operate on the time domain signals in the TX chains to prepare them for transmission on the component subcarrier of the RF chain. For wide bandwidth communications, more than one of the RF chains may process the symbols representing the data from the baseband processor(s) simultaneously.

The processor 570 decodes and processes the digital baseband signals, or downlink data, and invokes different functional modules to perform features in the UE 560. The memory 572 stores program instructions or code and data 574 to control the operations of the UE 560. The processor 570 may also execute medium access control (MAC) layer code of the code and data 574 for the UE 560. For instance, the MAC layer code may execute on the processor 570 to cause UL communications to transmit to the base station 510 via one or more of the RF chains of the physical layer (PHY). The PHY is the RF circuitry 594 and associated logic such as some or all the functional modules.

The host circuitry 562 may execute code such as RRC layer code to implement RRC layer functionality and code.

The base station 510 and the UE 560 may include several functional modules and circuits to carry out some embodiments. The different functional modules may include circuits or circuitry that code, hardware, or any combination thereof, can configure and implement. Each functional module that can implement functionality as code and processing circuitry or as circuitry configured to perform functionality, may also be referred to as a functional block. For example, the processor 520 (e.g., via executing program code 524) is a functional block to configure and implement the circuitry of the functional modules to allow the base station 510 to schedule (via scheduler 526), encode or decode (via codec 528), modulate or demodulate (via modulator 530), and transmit data to or receive data from the UE 560 via the RF circuitry 544 and the antenna 546.

The processor 570 (e.g., via executing program code in the code and data 574) may be a functional block to configure and implement the circuitry of the functional modules to allow the UE 560 to receive or transmit, de-modulate or modulate (via de-modulator 578), and decode or encode (via codec 576) data accordingly via the RF circuitry 594 and the antenna 596.

The base station 510 may also include a functional module, sense logic circuitry 535. The sense logic circuitry 535 of the base station 510 may cause the processor 520 and/or the host circuitry 512 to perform actions to perform network-based sensing based on a sensing request received from a SSMF. The processor 520 and/or the host circuitry 512 (which may include a host processor and a host memory with code and data) may parse the sensing request to determine one or more parameters associated with the sensing request such as a sensing type, a QoS level, a reporting type, a geographical area within which to perform the network-based sensing, a reporting mode, a frequency of reporting, a sensing algorithm to use for sensing, and/or the like. The sensing type may identify the type of sensing such as detection of objects, detection of rainfall intensity, pollution information, snow intensity, object shapes, object range or distance, object speed, object velocity, object rotational direction, object rotational speed, and/or the like.

The processor 520 and/or the host circuitry 512 may further perform one or more patterns of directional radio transmissions and receive echoes based on the radio transmissions to capture the sensor data. In some embodiments, the directions for the directional transmissions may be based on a geographical area parsed from the sensing request.

After capturing the sensor data and processing the sensor data based on the sensing algorithm, the processor 520 and/or the host circuitry 512 may produce a sensor result such as a data structure representative of a map of the environment that may be focused on the sensing type identified in the parameters of the sensing request. The processor 520 and/or the host circuitry 512 may send the sensing result to the SSMF based on the reporting mode and the reporting frequency.

In some embodiments, the processor 520 and/or the host circuitry 512 may further process the sensor data to detect event triggers identified in the parameters of the sensing request. In such embodiments, the processor 520 and/or the host circuitry 512 may send sensing results to the SSMF based on detection of the event triggers. The event triggers may relate to characteristics of the objects or the environment. For instance, an event trigger may comprise detection of rainfall or fog. In such embodiments, the processor 520 and/or the host circuitry 512 may process the echoes to detection layers of rainfall or fog that reflect and refract the radio transmissions at different distances, at different angles, and with different amplitudes than other objects within the environment.

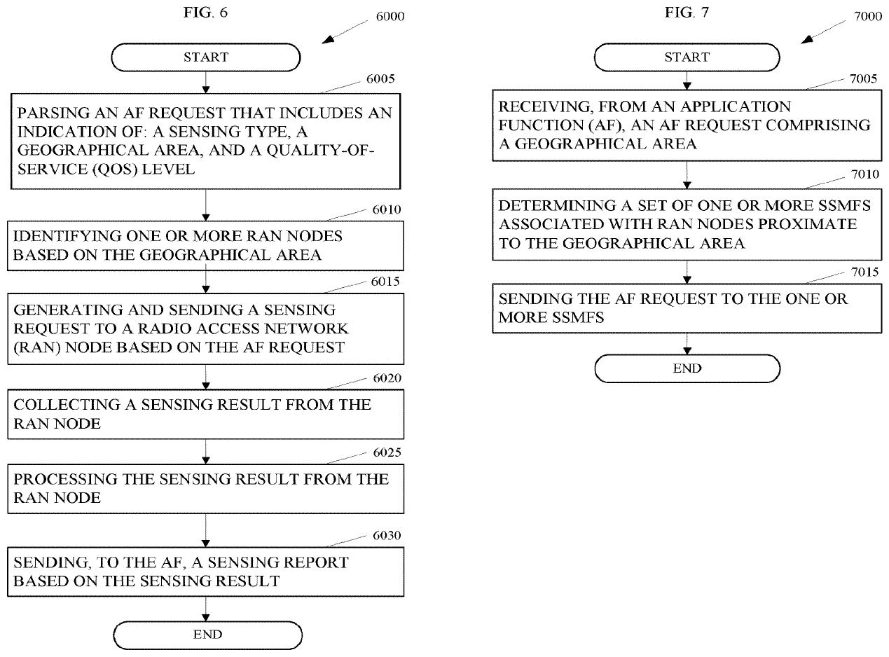

FIG. 6 depicts a flowchart 6000 of an embodiment for sense logic circuitry to perform network-based sensing such as the embodiments described in conjunction with FIGS. 1-5. An AF may generate and send a request to a NEF of a cellular network to request a network-based sensing service and the NEF may pass or send the AF request to an SSMF.

The flowchart 6000 begins with sense logic circuitry of an SSMF of the cellular network parsing the AF request that includes an indication of: a sensing type, a geographical area, and a quality-of-service (QoS) level (element 6005). In some embodiments, the sensing type may comprise an object shape, an object velocity, air pollution intensity, or rainfall intensity. In some embodiments, the AF request may also include parameters such as a reporting mode, a frequency of reporting, or a combination thereof.

The sense logic circuitry of the SSMF may identify a radio access network (RAN) node based on the first geographical area (element 6010). The sense logic circuitry of the SSMF may determine one or more RAN node IDs such as eNB IDs or gNB IDs for RAN nodes having a service area that overlaps or is within the first geographical area indicated in the AF request and may generate and send a sensing request to each of the RAN nodes identified (element 6015). The sense logic circuitry of the SSMF may generate each of the sensing request with a second set of parameters such as comprising a second geographical area, a sensing type, a reporting mode, a frequency of reporting, a QoS level, or a combination thereof.

After sending the sensing requests to the RAN nodes, the sense logic circuitry of the SSMF may collect a sensing result from each of the RAN nodes (element 6020). In some embodiments, the sense logic circuitry of the RAN nodes may generate sensing results and deliver the sensing results to the sense logic circuitry of the SSMF during dedicated resources for communication of the sensing results. In some embodiments, the sense logic circuitry of the SSMF may schedule resources for retrieval or collection of the sensing results from each of the RAN nodes. In further embodiments, the sense logic circuitry of the RAN nodes may schedule resources for communication of the sensing results. For instance, the frequency of reporting parameter may indicate that the reporting is event based. In such embodiments, the sense logic circuitry of the RAN nodes may communicate sensing results as snapshots of sensing data collected and processed by the RAN nodes and periodically transmit the sensing results to the SSMF. In other embodiments, the sense logic circuitry of the RAN nodes may process the sensor data to determine if an event occurred that triggers communication of the sensing results to the SSMF. In such embodiments, the sense logic circuitry of the RAN nodes may schedule resources from, e.g., a dedicated pool of resources or a shared pool of resources to send the sensing results to the SSMF.

After collecting the sensing results from each of the RAN nodes, the sense logic circuitry of the SSMF may process the sensing results from the RAN nodes (element 6025). In some embodiments, the sense logic circuitry of the SSMF may process the sensing results to determine if further sensing results are needed to generate a sensing report for the AF. For instance, the sense logic circuitry of the SSMF may determine that the sensing result from a first RAN node does not have sufficient granularity to determine whether an event trigger occurred. In such embodiments, the sense logic circuitry of the SSMF may generate a subsequent sensing request having a parameter of a QoS level that increases the granularity of the requested sensing result.

In some embodiments, the sense logic circuitry of the SSMF may process the sensing results to generate a sensing report based on a combination of one or more of the sensing results received from the RAN nodes. In further embodiments, the sense logic circuitry of the SSMF may process the sensing results based on values of one or more parameters of the AF request to generate a sensing report to send to the AF.

After processing the sensing results, the sense logic circuitry of the SSMF may send the sensing report to the AF via the sense logic circuitry of the NEF (element 6030). In some embodiments, the NEF may combine or group the sensing reports from more than one SSMF to generate a combined sensing report to send to the AF. In other embodiments, the NEF may send the sensing report from each of the SSMFs to the AF separately.

FIG. 7 depicts a flowchart 7000 of an embodiment for sense logic circuitry to perform network-based sensing such as the embodiments described in conjunction with FIGS. 1-6. The flowchart 7000 begins with sense logic circuitry of a NEF of a cellular network receiving, from an application function (AF), an AF request comprising a geographical area (element 7005). The sense logic circuitry of the NEF may parse the AF request to determine that the AF request is a request for network-based sensing and may authenticate and authorize the AF request via sense logic circuitry of a UDR. After, before, or during authenticating and authorizing the AF request, the NEF may parse the AF request to determine that the geographical area associated with the AF request. For instance, in some embodiments, authorization of the AF request may be based on the geographical area of associated with the AF request. In other embodiment, the sense logic circuitry of the NEF may determine that the AF request is authorized prior to determining the geographical area associated with the AF request.

After determining the geographical area associated with the AF request, the sense logic circuitry of the NEF may determine a set of one or more SSMFs associated with RAN nodes proximate to the geographical area (element 7010). In some embodiments, the AF request may be associated with a single SSMF in the cellular network. In such embodiments, the single SSMF may distribute the AF request to distributed sense logic circuitry of the SSMF for processing. In other embodiments, the cellular network may comprise more than one SSMFs, where each of the more than one SSMFs processes network-based sensing requests for a defined geographical area such as a town, a city, a state, a country, or other subdivisions of the geographical coverage of the cellular network. In such embodiments, the sense logic circuitry of the NEF may determine the set of one or more of the SSMFs that have service areas that overlap or are within the geographical area indicated in the AF request.

After determining the set of one or more of the SSMFs, the sense logic circuitry of the NEF may send the AF request to the set of one or more SSMFs (element 7015). In some embodiments, the sense logic circuitry of the NEF may generate a value or set of values to identify the geographical area associated with each of the SSMFs that describes the geographical areas within the service area of the SSMFs that overlap with the geographical area in the AF request. In such embodiments, the sense logic circuitry of the NEF may include different indications of geographical areas in the AF requests for each of the SSMFs. In other embodiments, the NEF may pass the AF request to each of the SSMFs with the geographical area for the entire AF request and each of the sense logic circuitry of the SSMFs may determine the overlap between their respective service areas and the geographical area associated with the entire AF request.

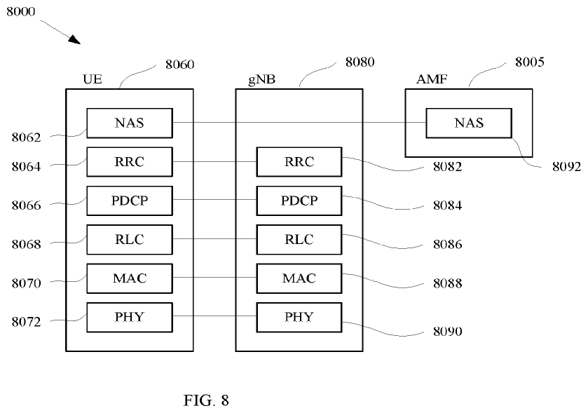

FIG. 8 depicts an embodiment of protocol entities 8000 that may be implemented in wireless communication devices, including one or more of a user equipment (UE) 8060, a base station, which may be termed an evolved node B (eNB), or a new radio, next generation node B (gNB) 8080, and a network function, which may be termed a mobility management entity (MME), or an access and mobility management function (AMF) 8094, according to some aspects. In further embodiments, the NodeB may comprise an xNodeB for a 6^{th} generation or later NodeB.

According to some aspects, gNB 8080 may be implemented as one or more of a dedicated physical device such as a macro-cell, a femto-cell or other suitable device, or in an alternative aspect, may be implemented as one or more software entities running on server computers as part of a virtual network termed a cloud radio access network (CRAN).

According to some aspects, one or more protocol entities that may be implemented in one or more of UE 8060, gNB 8080 and AMF 8094, may be described as implementing all or part of a protocol stack in which the layers are considered to be ordered from lowest to highest in the order physical layer (PHY), medium access control (MAC), radio link control (RLC), packet data convergence protocol (PDCP), radio resource control (RRC) and non-access stratum (NAS). According to some aspects, one or more protocol entities that may be implemented in one or more of UE 8060, gNB 8080 and AMF 8094, may communicate with a respective peer protocol entity that may be implemented on another device, using the services of respective lower layer protocol entities to perform such communication.

According to some aspects, UE PHY layer 8072 and peer entity gNB PHY layer 8090 may communicate using signals transmitted and received via a wireless medium. According to some aspects, UE MAC layer 8070 and peer entity gNB MAC layer 8088 may communicate using the services provided respectively by UE PHY layer 872 and gNB PHY layer 8090. According to some aspects, UE RLC layer 8068 and peer entity gNB RLC layer 8086 may communicate using the services provided respectively by UE MAC layer 8070 and gNB MAC layer 8088. According to some aspects, UE PDCP layer 8066 and peer entity gNB PDCP layer 8084 may communicate using the services provided respectively by UE RLC layer 8068 and 5GNB RLC layer 8086. According to some aspects, UE RRC layer 8064 and gNB RRC layer 8082 may communicate using the services provided respectively by UE PDCP layer 8066 and gNB PDCP layer 8084. According to some aspects, UE NAS 8062 and AMF NAS 8092 may communicate using the services provided respectively by UE RRC layer 8064 and gNB RRC layer 8082.

The PHY layer 8072 and 8090 may transmit or receive information used by the MAC layer 8070 and 8088 over one or more air interfaces. The PHY layer 8072 and 8090 may further perform link adaptation or adaptive modulation and coding (AMC), power control, cell search (e.g., for initial synchronization and handover purposes), and other measurements used by higher layers, such as the RRC layer 8064 and 8082. The PHY layer 8072 and 8090 may still further perform error detection on the transport channels, forward error correction (FEC) coding/decoding of the transport channels, modulation/demodulation of physical channels, interleaving, rate matching, mapping onto physical channels, and Multiple Input Multiple Output (MIMO) antenna processing.

The MAC layer 8070 and 8088 may perform mapping between logical channels and transport channels, multiplexing of MAC service data units (SDUs) from one or more logical channels onto transport blocks (TB) to be delivered to PHY via transport channels, de-multiplexing MAC SDUs to one or more logical channels from transport blocks (TB) delivered from the PHY via transport channels, multiplexing MAC SDUs onto TBs, scheduling information reporting, error correction through hybrid automatic repeat request (HARQ), and logical channel prioritization.

The RLC layer 8068 and 8086 may operate in a plurality of modes of operation, including: Transparent Mode (TM), Unacknowledged Mode (UM), and Acknowledged Mode (AM). The RLC layer 8068 and 8086 may execute transfer of upper layer protocol data units (PDUs), error correction through automatic repeat request (ARQ) for AM data transfers, and concatenation, segmentation and reassembly of RLC SDUs for UM and AM data transfers. The RLC layer 8068 and 8086 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

The PDCP layer 8066 and 8084 may execute header compression and decompression of Internet Protocol (IP) data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

The main services and functions of the RRC layer 8064 and 8082 may include broadcast of system information (e.g., included in Master Information Blocks (MIBs) or System Information Blocks (SIBs) related to the non-access stratum (NAS)), broadcast of system information related to the access stratum (AS), paging, establishment, maintenance and release of an RRC connection between the UE and E-UTRAN (e.g., RRC connection paging, RRC connection establishment, RRC connection modification, and RRC connection release), establishment, configuration, maintenance and release of point to point Radio Bearers, security functions including key management, inter radio access technology (RAT) mobility, and measurement configuration for UE measurement reporting. Said MIBs and SIBs may comprise one or more information elements (IEs), which may each comprise individual data fields or data structures.

The UE 8060 and the RAN node, gNB 8080 may utilize a Uu interface (e.g., an LTE-Uu interface) to exchange control plane data via a protocol stack comprising the PHY layer 8072 and 8090, the MAC layer 8070 and 8088, the RLC layer 8068 and 8086, the PDCP layer 8066 and 8084, and the RRC layer 8064 and 8082.

The non-access stratum (NAS) protocols 8092 form the highest stratum of the control plane between the UE 8060 and the AMF 8005. The NAS protocols 8092 support the mobility of the UE 8060 and the session management procedures to establish and maintain IP connectivity between the UE 8060 and the Packet Data Network (PDN) Gateway (P-GW).

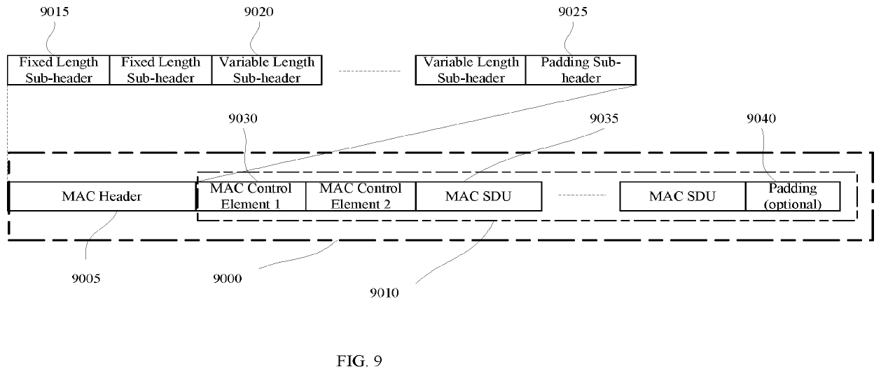

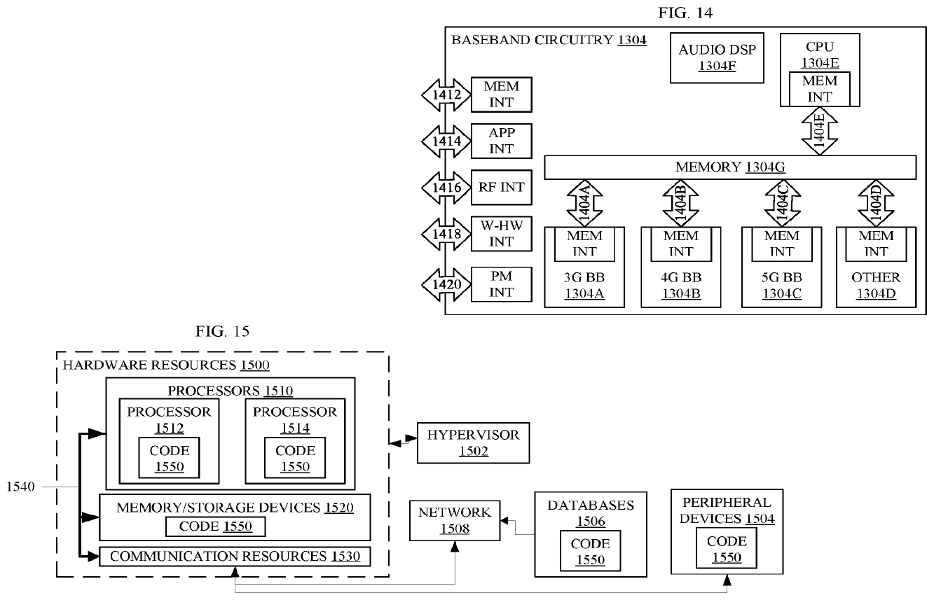

FIG. 9 illustrates embodiments of the formats of PHY data units (PDUs) that may be transmitted by the PHY device via one or more antennas and be encoded and decoded by a MAC entity such as the processors 520 and 570 in FIG. 5, the baseband circuitry 1304 in FIGS. 13 and 14 according to some aspects. In several embodiments, higher layer frames such as a frame comprising an RRC layer information element may transmit from the base station to the UE or vice versa as one or more MAC Service Data Units (MSDUs) in a payload of one or more PDUs in one or more subframes of a radio frame.

According to some aspects, a MAC PDU 9100 may consist of a MAC header 9105 and a MAC payload 9110, the MAC payload consisting of zero or more MAC control elements 9130, zero or more MAC service data unit (SDU) portions 9135 and zero or one padding portion 9140. According to some aspects, MAC header 8105 may consist of one or more MAC sub-headers, each of which may correspond to a MAC payload portion and appear in corresponding order. According to some aspects, each of the zero or more MAC control elements 9130 contained in MAC payload 9110 may correspond to a fixed length sub-header 9115 contained in MAC header 9105. According to some aspects, each of the zero or more MAC SDU portions 9135 contained in MAC payload 9110 may correspond to a variable length sub-header 9120 contained in MAC header 8105. According to some aspects, padding portion 9140 contained in MAC payload 9110 may correspond to a padding sub-header 9125 contained in MAC header 9105.

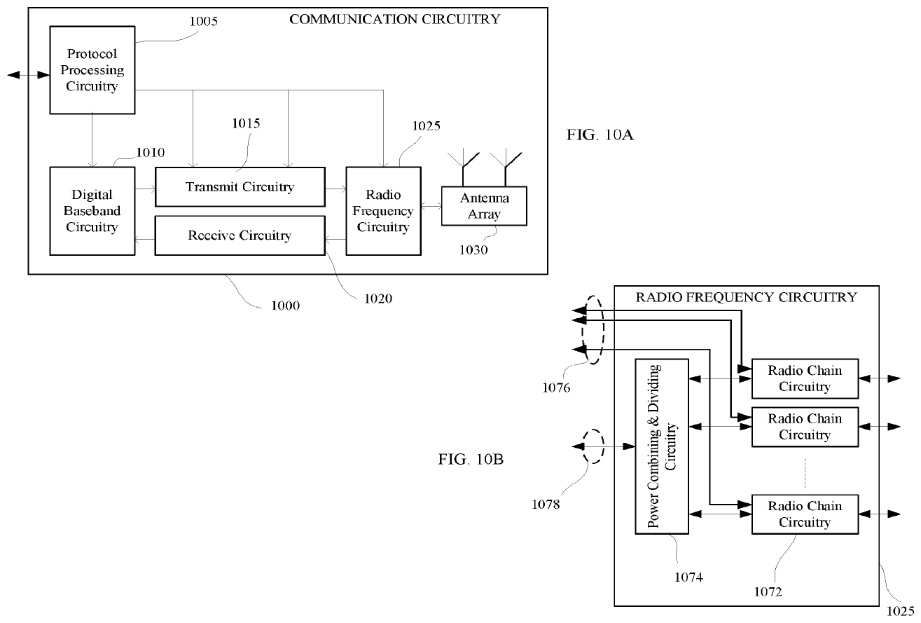

FIG. 10A illustrates an embodiment of communication circuitry 1000 such as the circuitry in the base station 510 and the user equipment 560 shown in FIG. 5. The communication circuitry 1000 is alternatively grouped according to functions. Components as shown in the communication circuitry 1000 are shown here for illustrative purposes and may include other components not shown here in FIG. 10A.

The communication circuitry 1000 may include protocol processing circuitry 1005, which may implement one or more of medium access control (MAC), radio link control (RLC), packet data convergence protocol (PDCP), radio resource control (RRC) and non-access stratum (NAS) functions. The protocol processing circuitry 1005 may include one or more processing cores (not shown) to execute instructions and one or more memory structures (not shown) to store program (code) and data information.

The communication circuitry 1000 may further include digital baseband circuitry 1010, which may implement physical layer (PHY) functions including one or more of hybrid automatic repeat request (HARQ) functions, scrambling and/or descrambling, coding and/or decoding, layer mapping and/or dc-mapping, modulation symbol mapping, received symbol and/or bit metric determination, multi-antenna port pre-coding and/or decoding which may include one or more of space-time, space-frequency or spatial coding, reference signal generation and/or detection, preamble sequence generation and/or decoding, synchronization sequence generation and/or detection, control channel signal blind decoding, and other related functions.

The communication circuitry 1000 may further include transmit circuitry 1015, receive circuitry 1020 and/or antenna array 1030 circuitry.

The communication circuitry 1000 may further include radio frequency (RF) circuitry 1025 such as the RF circuitry 544 and 594 in FIG. 5. In an aspect of an embodiment, RF circuitry 1025 may include multiple parallel RF chains for one or more of transmit or receive functions, each connected to one or more antennas of the antenna array 1030.

In an aspect of the disclosure, the protocol processing circuitry 1005 may include one or more instances of control circuitry (not shown) to provide control functions for one or more of digital baseband circuitry 1010, transmit circuitry 1015, receive circuitry 1020, and/or radio frequency circuitry 1025.

FIG. 10B illustrates an embodiment of radio frequency circuitry 1025 in FIG. 10A according to some aspects such as a RF circuitry 544 and 594 illustrated in FIG. 5. The radio frequency circuitry 1025 may include one or more instances of radio chain circuitry 1072, which in some aspects may include one or more filters, power amplifiers, low noise amplifiers, programmable phase shifters and power supplies (not shown).

The radio frequency circuitry 1025 may include power combining and dividing circuitry 1074. In some aspects, power combining and dividing circuitry 1074 may operate bidirectionally, such that the same physical circuitry may be configured to operate as a power divider when the device is transmitting, and as a power combiner when the device is receiving. In some aspects, power combining and dividing circuitry 1074 may one or more include wholly or partially separate circuitries to perform power dividing when the device is transmitting and power combining when the device is receiving. In some aspects, power combining and dividing circuitry 1074 may include passive circuitry comprising one or more two-way power divider/combiners arranged in a tree. In some aspects, power combining and dividing circuitry 1074 may include active circuitry comprising amplifier circuits.

In some aspects, the radio frequency circuitry 1025 may connect to transmit circuitry 1015 and receive circuitry 1020 in FIG. 10A via one or more radio chain interfaces 1076 or a combined radio chain interface 1078. The combined radio chain interface 1078 may form a wide or very wide bandwidth.

In some aspects, one or more radio chain interfaces 1076 may provide one or more interfaces to one or more receive or transmit signals, each associated with a single antenna structure which may comprise one or more antennas.

In some aspects, the combined radio chain interface 1078 may provide a single interface to one or more receive or transmit signals, each associated with a group of antenna structures comprising one or more antennas.

FIG. 11 illustrates an example of a storage medium 1100 to store code and data for execution by any one or more of the processors and/or processing circuitry to perform the functionality of the sense logic circuitry described herein. Storage medium 1100 may comprise an article of manufacture. In some examples, storage medium 1100 may include any non-transitory computer readable medium or machine-readable medium, such as an optical, magnetic or semiconductor storage. Storage medium 1100 may store diverse types of computer executable instructions, such as instructions to implement logic flows and/or techniques described herein. Examples of a computer readable or machine-readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like.

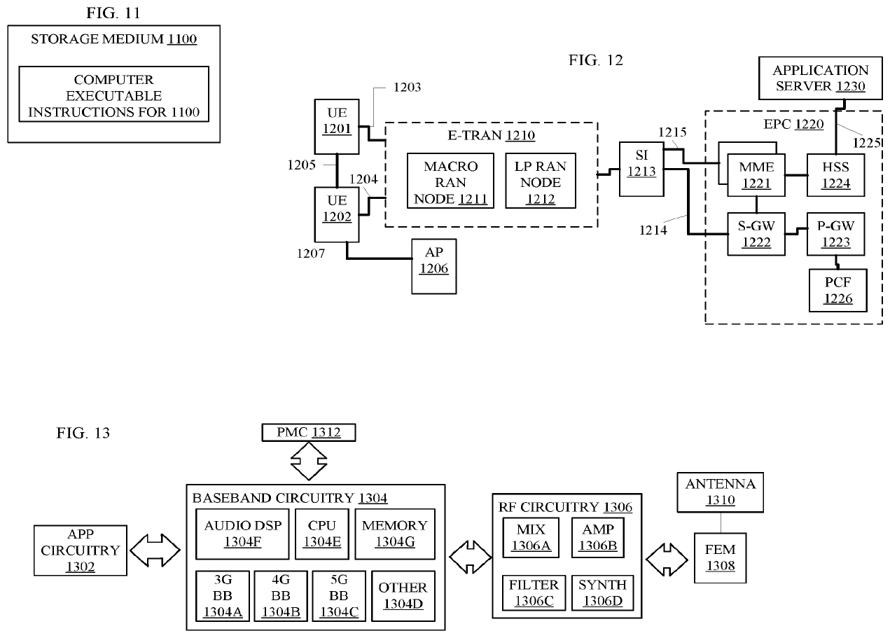

FIG. 12 illustrates an architecture of a system 1200 of a network in accordance with some embodiments. The system 1200 is shown to include a user equipment (UE) 1510 and a UE 1522 such as the UEs shown in FIGS. 1-11. The UEs 1510 and 1522 are illustrated as smartphones (e.g., handheld touch screen mobile computing devices connectable to one or more cellular networks) but may also comprise any mobile or non-mobile computing device, such as Personal Data Assistants (PDAs), pagers, laptop computers, desktop computers, wireless handsets, or any computing device including a wireless communications interface.

In some embodiments, any of the UEs 1510 and 1522 can comprise an Internet of Things (IoT) UE, which can comprise a network access layer designed for low-power IoT applications utilizing short-lived UE connections. An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network.

The UEs 1510 and 1522 may to connect, e.g., communicatively couple, with a radio access network (RAN)-in this embodiment, an Evolved Universal Mobile Telecommunications System (UMTS) Terrestrial Radio Access Network (E-UTRAN) 1210 such as the base stations shown in FIGS. 1-11. The UEs 1510 and 1522 utilize connections 1520 and 1204, respectively, each of which comprises a physical communications interface or layer (discussed in further detail below); in this example, the connections 1520 and 1204 are illustrated as an air interface to enable communicative coupling, and can be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a fifth generation (5G) protocol, a New Radio (NR) protocol, and the like.

In this embodiment, the UEs 1510 and 1522 may further directly exchange communication data via a ProSe interface 1205. The ProSe interface 1205 may alternatively be referred to as a sidelink interface comprising one or more logical channels, including but not limited to a Physical Sidelink Control Channel (PSCCH), a Physical Sidelink Shared Channel (PSSCH), a Physical Sidelink Discovery Channel (PSDCH), and a Physical Sidelink Broadcast Channel (PSBCH).

The UE 1522 is shown to be configured to access an access point (AP) 1206 via connection 1207. The connection 1207 can comprise a local wireless connection, such as a connection consistent with any IEEE 802.11 protocol, wherein the AP 1206 would comprise a wireless fidelity (WiFi®) router. In this example, the AP 1206 is shown to be connected to the Internet without connecting to the core network of the wireless system (described in further detail below). The E-UTRAN 1210 can include one or more access nodes that enable the connections 1520 and 1204. These access nodes (ANs) can be referred to as base stations (BSs), NodeBs, evolved NodeBs (eNBs), next Generation NodeBs (gNB), RAN nodes, and so forth, and can comprise ground stations (e.g., terrestrial access points) or satellite stations providing coverage within a geographic area (e.g., a cell). The E-UTRAN 1210 may include one or more RAN nodes for providing macrocells, e.g., macro RAN node 1560, and one or more RAN nodes for providing femto-cells or picocells (e.g., cells having smaller coverage areas, smaller user capacity, or higher bandwidth compared to macro-cells), e.g., low power (LP) RAN node 1572.

Any of the RAN nodes 1560 and 1572 can terminate the air interface protocol and can be the first point of contact for the UEs 1510 and 1522. In some embodiments, any of the RAN nodes 1560 and 1572 can fulfill various logical functions for the E-UTRAN 1210 including, but not limited to, radio network controller (RNC) functions such as radio bearer management, uplink and downlink dynamic radio resource management and data packet scheduling, and mobility management.

In accordance with some embodiments, the UEs 1510 and 1522 can be configured to communicate using Orthogonal Frequency-Division Multiplexing (OFDM) communication signals with each other or with any of the RAN nodes 1560 and 1572 over a multicarrier communication channel in accordance various communication techniques, such as, but not limited to, an Orthogonal Frequency-Division Multiple Access (OFDMA) communication technique (e.g., for downlink communications) or a Single Carrier Frequency Division Multiple Access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, a downlink resource grid can be used for downlink transmissions from any of the RAN nodes 1560 and 1572 to the UEs 1510 and 1522, while uplink transmissions can utilize similar techniques. The grid can be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid is denoted as a resource element. Each resource grid comprises a number of resource blocks, which describe the mapping of certain physical channels to resource elements. Each resource block comprises a collection of resource elements; in the frequency domain, this may represent the smallest quantity of resources that currently can be allocated. There are several different physical downlink (DL) channels that are conveyed using such resource blocks.

The physical downlink shared channel (PDSCH) may carry user data and higher-layer signaling to the UEs 1510 and 1522. The physical downlink control channel (PDCCH) may carry information about the transport format and resource allocations related to the PDSCH channel, among other things. It may also inform the UEs 1510 and 1522 about the transport format, resource allocation, and HARQ (Hybrid Automatic Repeat Request) information related to the uplink shared channel. Typically, downlink scheduling (assigning control and shared channel resource blocks to the UE 102 within a cell) may be performed at any of the RAN nodes 1560 and 1572 based on channel quality information fed back from any of the UEs 1510 and 1522. The downlink resource assignment information may be sent on the PDCCH used for (e.g., assigned to) each of the UEs 1510 and 1522.

The PDCCH may use control channel elements (CCEs) to convey the control information. Before being mapped to resource elements, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical resource elements known as resource element groups (REGs). Four Quadrature Phase Shift Keying (QPSK) symbols may be mapped to each REG. The PDCCH can be transmitted using one or more CCEs, depending on the size of the downlink control information (DCI) and the channel condition. There can be four or more different PDCCH formats defined in LTE with different numbers of CCEs (e.g., aggregation level, L=1, 2, 4, or 8).

Some embodiments may use concepts for resource allocation for control channel information that are an extension of the above-described concepts. For example, some embodiments may utilize an enhanced physical downlink control channel (EPDCCH) that uses PDSCH resources for control information transmission. The EPDCCH may be transmitted using one or more enhanced the control channel elements (ECCEs). Similar to above, each ECCE may correspond to nine sets of four physical resource elements known as an enhanced resource element groups (EREGs). An ECCE may have other numbers of EREGs in some situations.

The RAN nodes 1560 and 1572 may communicate with one another and/or with other access nodes in the E-UTRAN 1210 and/or in another RAN via an X2 interface, which is a signaling interface for communicating data packets between ANs. Some other suitable interface for communicating data packets directly between ANs may be used.

The E-UTRAN 1210 is shown to be communicatively coupled to a core network-in this embodiment, an Evolved Packet Core (EPC) network 1220 via an SI interface 1570. In this embodiment the SI interface 1570 is split into two parts: the SI-U interface 1214, which carries traffic data between the RAN nodes 1560 and 1572 and the serving gateway (S-GW) 1222, and the SI-mobility management entity (MME) interface 1215, which is a signaling interface between the RAN nodes 1560 and 1572 and MMEs 1546.

In this embodiment, the EPC network 1220 comprises the MMEs 1546, the S-GW 1222, the Packet Data Network (PDN) Gateway (P-GW) 1223, and a home subscriber server (HSS) 1224. The MMEs 1546 may be similar in function to the control plane of legacy Serving General Packet Radio Service (GPRS) Support Nodes (SGSN). The MMEs 1546 may manage mobility aspects in access such as gateway selection and tracking area list management. The HSS 1224 may comprise a database for network users, including subscription-related information to support the network entities' handling of communication sessions. The EPC network 1220 may comprise one or several HSSs 1224, depending on the number of mobile subscribers, on the capacity of the equipment, on the organization of the network, etc. For example, the HSS 1224 can provide support for routing/roaming, authentication, authorization, naming/addressing resolution, location dependencies, etc.

The S-GW 1222 may terminate the SI interface 1570 towards the E-UTRAN 1210, and routes data packets between the E-UTRAN 1210 and the EPC network 1220. In addition, the S-GW 1222 may be a local mobility anchor point for inter-RAN node handovers and also may provide an anchor for inter-3GPP mobility. Other responsibilities may include lawful intercept, charging, and some policy enforcement.

The P-GW 1223 may terminate an SGi interface toward a PDN. The P-GW 1223 may route data packets between the EPC network 1220 and external networks such as a network including the application server 1230 (alternatively referred to as application function (AF)) via an Internet Protocol (IP) interface 1225. Generally, the application server 1230 may be an element offering applications that use IP bearer resources with the core network (e.g., UMTS Packet Services (PS) domain, LTE PS data services, etc.). In this embodiment, the P-GW 1223 is shown to be communicatively coupled to an application server 1230 via an IP interface 1225. The application server 1230 can also be configured to support one or more communication services (e.g., Voice-over-Internet Protocol (VoIP) sessions, PTT sessions, group communication sessions, social networking services, etc.) for the UEs 1510 and 1522 via the EPC network 1220.

The P-GW 1223 may further be a node for policy enforcement and charging data collection. Policy and Charging Enforcement Function (PCRF) 1226 is the policy and charging control element of the EPC network 1220. In a non-roaming scenario, there may be a single PCRF in the Home Public Land Mobile Network (HPLMN) associated with a UE's Internet Protocol Connectivity Access Network (IP-CAN) session. In a roaming scenario with local breakout of traffic, there may be two PCRFs associated with a UE's IP-CAN session: a Home PCRF (H-PCRF) within a HPLMN and a Visited PCRF (V-PCRF) within a Visited Public Land Mobile Network (VPLMN). The PCRF 1226 may be communicatively coupled to the application server 1230 via the P-GW 1223. The application server 1230 may signal the PCRF 1226 to indicate a new service flow and select the appropriate Quality of Service (QoS) and charging parameters. The PCRF 1226 may provision this rule into a Policy and Charging Enforcement Function (PCEF) (not shown) with the appropriate traffic flow template (TFT) and QoS class of identifier (QCI), which commences the QoS and charging as specified by the application server 1230.

FIG. 13 illustrates example components of a device 1300 in accordance with some embodiments such as the base stations and UEs shown in FIGS. 1-12. In some embodiments, the device 1300 may include application circuitry 1302, baseband circuitry 1304, Radio Frequency (RF) circuitry 1306, front-end module (FEM) circuitry 1308, one or more antennas 1310, and power management circuitry (PMC) 1312 coupled together at least as shown. The components of the illustrated device 1300 may be included in a UE or a RAN node such as a base station or gNB. In some embodiments, the device 1300 may include less elements (e.g., a RAN node may not utilize application circuitry 1302, and instead include a processor/controller to process IP data received from an EPC). In some embodiments, the device 1300 may include additional elements such as, for example, memory/storage, display, camera, sensor, or input/output (I/0) interface. In other embodiments, the components described below may be included in more than one device (e.g., said circuitries may be separately included in more than one device for Cloud-RAN (C-RAN) implementations).

The application circuitry 1302 may include one or more application processors. For example, the application circuitry 1302 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the device 1300. In some embodiments, processors of application circuitry 1302 may process IP data packets received from an EPC.

The baseband circuitry 1304 may include circuitry such as, but not limited to, one or more single-core or multi-core processors. The baseband circuitry 1304 may include one or more baseband processors or control logic to process baseband signals received from a receive signal path of the RF circuitry 1306 and to generate baseband signals for a transmit signal path of the RF circuitry 1306. The baseband circuity 1304 may interface with the application circuitry 1302 for generation and processing of the baseband signals and for controlling operations of the RF circuitry 1306. For example, in some embodiments, the baseband circuitry 1304 may include a third generation (3G) baseband processor 1304A, a fourth generation (4G) baseband processor 1304B, a fifth generation (5G) baseband processor 1304C, or other baseband processor(s) 1304D for other existing generations, generations in development or to be developed in the future (e.g., second generation (2G), sixth generation (6G), etc.). In many embodiments, the fourth generation (4G) baseband processor 1304B may include capabilities for generation and processing of the baseband signals for LTE radios and the fifth generation (5G) baseband processor 1304C may capabilities for generation and processing of the baseband signals for NRs.

The baseband circuitry 1304 (e.g., one or more of baseband processors 1304A-D) may handle various radio control functions that enable communication with one or more radio networks via the RF circuitry 1306. In other embodiments, some of or all the functionality of baseband processors 1304A-D may be included in modules stored in the memory 1304G and executed via a Central Processing Unit (CPU) 1304E. The radio control functions may include, but are not limited to, signal modulation/demodulation, encoding/decoding, radio frequency shifting, etc.

In some embodiments, modulation/demodulation circuitry of the baseband circuitry 1304 may include Fast-Fourier Transform (FFT), precoding, or constellation mapping/demapping functionality. In some embodiments, encoding/decoding circuitry of the baseband circuitry 1304 may include convolution, tail-biting convolution, turbo, Viterbi, or Low-Density Parity Check (LDPC) encoder/decoder functionality. Embodiments of modulation/demodulation and encoder/decoder functionality are not limited to these examples and may include other suitable functionality in other embodiments.

In some embodiments, the baseband circuitry 1304 may include one or more audio digital signal processor(s) (DSP) 1304F. The audio DSP(s) 1304F may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some of or all the constituent components of the baseband circuitry 1304 and the application circuitry 1302 may be implemented together such as, for example, on a system on a chip (SOC). In some embodiments, the baseband circuitry 1304 may provide for communication compatible with one or more radio technologies. For example, in some embodiments, the baseband circuitry 1304 may support communication with an evolved universal terrestrial radio access network (E-UTRAN) or other wireless metropolitan area networks (WMAN), a wireless local area network (WLAN), a wireless personal area network (WPAN). Embodiments in which the baseband circuitry 1304 is configured to support radio communications of more than one wireless protocol may be referred to as multi-mode baseband circuitry.

The RF circuitry 1306 may enable communication with wireless networks using modulated electromagnetic radiation through a non-solid medium. In various embodiments, the RF circuitry 1306 may include switches, filters, amplifiers, etc. to facilitate the communication with the wireless network. The RF circuitry 1306 may include a receive signal path which may include circuitry to down-convert RF signals received from the FEM circuitry 1308 and provide baseband signals to the baseband circuitry 1304. The RF circuitry 1306 may also include a transmit signal path which may include circuitry to up-convert baseband signals provided by the baseband circuitry 1304 and provide RF output signals to the FEM circuitry 1308 for transmission.

In some embodiments, the receive signal path of the RF circuitry 1306 may include mixer circuitry 1306a, amplifier circuitry 1306b and filter circuitry 1306c. In some embodiments, the transmit signal path of the RF circuitry 1306 may include filter circuitry 1306c and mixer circuitry 1306a. The RF circuitry 1306 may also include synthesizer circuitry 1306d for synthesizing a frequency, or component carrier, for use by the mixer circuitry 1306a of the receive signal path and the transmit signal path. In some embodiments, the mixer circuitry 1306a of the receive signal path may to down-convert RF signals received from the FEM circuitry 1308 based on the synthesized frequency provided by synthesizer circuitry 1306d. The amplifier circuitry 1306b may amplify the down-converted signals and the filter circuitry 1306c may be a low-pass filter (LPF) or band-pass filter (BPF) to remove unwanted signals from the down-converted signals to generate output baseband signals. Output baseband signals may be provided to the baseband circuitry 1304 for further processing.

In some embodiments, the output baseband signals may be zero-frequency baseband signals, although this is not a requirement. In some embodiments, mixer circuitry 1306a of the receive signal path may comprise passive mixers, although the scope of the embodiments is not limited in this respect.

In some embodiments, the mixer circuitry 1306a of the transmit signal path may be configured to up-convert input baseband signals based on the synthesized frequency provided by the synthesizer circuitry 1306d to generate RF output signals for the FEM circuitry 1308. The baseband signals may be provided by the baseband circuitry 1304 and may be filtered by filter circuitry 1306c.

In some embodiments, the mixer circuitry 1306a of the receive signal path and the mixer circuitry 1306a of the transmit signal path may include two or more mixers and may be arranged for quadrature downconversion and upconversion, respectively. In some embodiments, the mixer circuitry 1306a of the receive signal path and the mixer circuitry 1306a of the transmit signal path may include two or more mixers and may be arranged for image rejection (e.g., Hartley image rejection). In some embodiments, the mixer circuitry 1306a of the receive signal path and the mixer circuitry 1306a may be arranged for direct downconversion and direct upconversion, respectively. In some embodiments, the mixer circuitry 1306a of the receive signal path and the mixer circuitry 1306a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 1306 may include analog-to-digital converter (ADC) and digital-to-analog converter (DAC) circuitry and the baseband circuitry 1304 may include a digital baseband interface to communicate with the RF circuitry 1306.

In some dual-mode embodiments, a separate radio IC circuitry may be provided for processing signals for each spectrum, although the scope of the embodiments is not limited in this respect.

In some embodiments, the synthesizer circuitry 1306d may be a fractional-N synthesizer or a fractional NIN+I synthesizer, although the scope of the embodiments is not limited in this respect as other types of frequency synthesizers may be suitable. For example, synthesizer circuitry 1306d may be a delta-sigma synthesizer, a frequency multiplier, or a synthesizer comprising a phase-locked loop with a frequency divider.

The synthesizer circuitry 1306d may synthesize an output frequency for use by the mixer circuitry 1306a of the RF circuitry 1306 based on a frequency input and a divider control input. In some embodiments, the synthesizer circuitry 1306d may be a fractional NIN+I synthesizer.

In some embodiments, frequency input may be an output of a voltage-controlled oscillator (VCO), although that is not a requirement. Divider control input may be an output of either the baseband circuitry 1304 or an application processor of the applications circuitry 1302 depending on the desired output frequency. Some embodiments may determine a divider control input (e.g., N) from a look-up table based on a channel indicated by the applications circuitry 1302.

The synthesizer circuitry 1306d of the RF circuitry 1306 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may break a VCO period up into Nd equal packets of phase, where Nd is the number of delay elements in the delay line. In this way, the DLL provides negative feedback to help ensure that the total delay through the delay line is one VCO cycle.

In some embodiments, the synthesizer circuitry 1306d may generate a carrier frequency (or component carrier) as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a local oscillator (LO) frequency (fLO). In some embodiments, the RF circuitry 1306 may include an IQ/polar converter.

The FEM circuitry 1308 may include a receive signal path which may include circuitry to operate on RF signals received from one or more antennas 1310, amplify the received signals and provide the amplified versions of the received signals to the RF circuitry 1306 for further processing. FEM circuitry 1308 may also include a transmit signal path which may include circuitry configured to amplify signals for transmission provided by the RF circuitry 1306 for transmission by one or more of the one or more antennas 1310. In various embodiments, the amplification through the transmit or receive signal paths may be done solely in the RF circuitry 1306, solely in the FEM circuitry 1308, or in both the RF circuitry 1306 and the FEM circuitry 1308.

In some embodiments, the FEM circuitry 1308 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 1306). The transmit signal path of the FEM circuitry 1308 may include a power amplifier (PA) to amplify input RF signals (e.g., provided by RF circuitry 1306), and one or more filters to generate RF signals for subsequent transmission (e.g., by one or more of the one or more antennas 1310).

In the present embodiment, the radio refers to a combination of the RF circuitry 130 and the FEM circuitry 1308. The radio refers to the portion of the circuitry that generates and transmits or receives and processes the radio signals. The RF circuitry 1306 includes a transmitter to generate the time domain radio signals with the data from the baseband signals and apply the radio signals to subcarriers of the carrier frequency that form the bandwidth of the channel. The PA in the FEM circuitry 1308 amplifies the tones for transmission and amplifies tones received from the one or more antennas 1310 via the LNA to increase the signal-to-noise ratio (SNR) for interpretation. In wireless communications, the FEM circuitry 1308 may also search for a detectable pattern that appears to be a wireless communication. Thereafter, a receiver in the RF circuitry 1306 converts the time domain radio signals to baseband signals via one or more functional modules such as the functional modules shown in the base station 510 and the user equipment 560 illustrated in FIG. 2.

In some embodiments, the PMC 1312 may manage power provided to the baseband circuitry 1304. In particular, the PMC 1312 may control power-source selection, voltage scaling, battery charging, or DC-to-DC conversion. The PMC 1312 may often be included when the device 1300 is capable of being powered by a battery, for example, when the device is included in a UE. The PMC 1312 may increase the power conversion efficiency while providing desirable implementation size and heat dissipation characteristics.

While FIG. 13 shows the PMC 1312 coupled only with the baseband circuitry 1304. However, in other embodiments, the PMC 1312 may be additionally or alternatively coupled with, and perform similar power management operations for, other components such as, but not limited to, application circuitry 1302, RF circuitry 1306, or FEM circuitry 1308.

In some embodiments, the PMC 1312 may control, or otherwise be part of, various power saving mechanisms of the device 1300. For example, if the device 1300 is in an RRC _ Connected state, where it is still connected to the RAN node as it expects to receive traffic shortly, then it may enter a state known as Discontinuous Reception Mode (DRX) after a period of inactivity. During this state, the device 1300 may power down for brief intervals of time and thus save power.

If there is no data traffic activity for an extended period of time, then the device 1300 may transition off to an RRC Idle state, where it disconnects from the network and does not perform operations such as channel quality feedback, handover, etc. The device 1300 goes into a very low power state and it performs paging where again it periodically wakes up to listen to the network and then powers down again. The device 1300 may not receive data in this state, in order to receive data, it must transition back to RRC Connected state.

An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

The processors of the application circuitry 1302 and the processors of the baseband circuitry 1304 may be used to execute elements of one or more instances of a protocol stack. For example, processors of the baseband circuitry 1304, alone or in combination, may be used execute Layer 3, Layer 2, or Layer 1 functionality, while processors of the application circuitry 1302 may utilize data (e.g., packet data) received from these layers and further execute Layer 4 functionality (e.g., transmission communication protocol (TCP) and user datagram protocol (UDP) layers). As referred to herein, Layer 3 may comprise a radio resource control (RRC) layer, described in further detail below. As referred to herein, Layer 2 may comprise a medium access control (MAC) layer, a radio link control (RLC) layer, and a packet data convergence protocol (PDCP) layer, described in further detail below. As referred to herein, Layer 1 may comprise a physical (PHY) layer of a UE/RAN node, described in further detail below.

FIG. 14 illustrates example interfaces of baseband circuitry in accordance with some embodiments such as the baseband circuitry shown and/or discussed in conjunction with FIGS. 1-13. As discussed above, the baseband circuitry 1304 of FIG. 13 may comprise processors 1304A-1304E and a memory 1304G utilized by said processors. Each of the processors 1304A-1304E may include a memory interface, 1404A-1404E, respectively, to send/receive data to/from the memory 1304G.

The baseband circuitry 1304 may further include one or more interfaces to communicatively couple to other circuitries/devices, such as a memory interface 1412 (e.g., an interface to send/receive data to/from memory external to the baseband circuitry 1304), an application circuitry interface 1414 (e.g., an interface to send/receive data to/from the application circuitry 1302 of FIG. 13), an RF circuitry interface 1416 (e.g., an interface to send/receive data to/from RF circuitry 1306 of FIG. 13), a wireless hardware connectivity interface 1418 (e.g., an interface to send/receive data to/from Near Field Communication (NFC) components, Bluetooth® components (e.g., Bluetooth® Low Energy), Wi-Fi® components, and other communication components), and a power management interface 1420 (e.g., an interface to send/receive power or control signals to/from the PMC 1312.

FIG. 15 is a block diagram illustrating components with sense logic circuitry, according to some example embodiments, able to read instructions from a machine-readable or computer-readable medium (e.g., a non-transitory machine-readable storage medium) and perform any one or more of the methodologies discussed herein. Specifically, FIG. 15 shows a diagrammatic representation of hardware resources 1500 including one or more processors (or processor cores) 1510, one or more memory/storage devices 1520, and one or more communication resources 1530, each of which may be communicatively coupled via a bus 1540. For embodiments where node virtualization (e.g., NFV) is utilized, a hypervisor 1502 may be executed to provide an execution environment for one or more network slices/sub-slices to utilize the hardware resources 1500.

The processors 1510 (e.g., a central processing unit (CPU), a reduced instruction set computing (RISC) processor, a complex instruction set computing (CISC) processor, a graphics processing unit (GPU), a digital signal processor (DSP) such as a baseband processor, an application specific integrated circuit (ASIC), a radio-frequency integrated circuit (RFIC), another processor, or any suitable combination thereof) may include, for example, a processor 1512 and a processor 1514.

The memory/storage devices 1520 may include main memory, disk storage, or any suitable combination thereof. The memory/storage devices 1520 may include, but are not limited to any type of volatile or non-volatile memory such as dynamic random-access memory (DRAM), static random-access memory (SRAM), erasable programmable read-only memory (EPROM), electrically erasable programmable read-only memory (EEPROM), Flash memory, solid-state storage, etc.

The communication resources 1530 may include interconnection or network interface components or other suitable devices to communicate with one or more peripheral devices 1504 or one or more databases 1506 via a network 1508. For example, the communication resources 1530 may include wired communication components (e.g., for coupling via a Universal Serial Bus (USB)), cellular communication components, NFC components, Bluetooth® components (e.g., Bluetooth® Low Energy), Wi-Fi® components, and other communication components.

Instructions 1550 may comprise software, a program, an application, an applet, an app, or other executable code for causing at least any of the processors 1510 to perform any one or more of the methodologies discussed herein. The instructions 1550 may reside, completely or partially, within at least one of the processors 1510 (e.g., within the processor's cache memory), the memory/storage devices 1520, or any suitable combination thereof. Furthermore, any portion of the instructions 1550 may be transferred to the hardware resources 1500 from any combination of the peripheral devices 1504 or the databases 1506. Accordingly, the memory of processors 1510, the memory/storage devices 1520, the peripheral devices 1504, and the databases 1506 are examples of computer-readable and machine-readable media.

In embodiments, one or more elements of FIGS. 12, 13, 14, and/or 15 may be configured to perform one or more processes, techniques, or methods as described herein, or portions thereof. In embodiments, one or more elements of FIGS. 12, 13, 14, and/or 15 may be configured to perform one or more processes, techniques, or methods, or portions thereof, as described in the following examples.

As used herein, the term “circuitry” may refer to, be part of, or include an Application Specific Integrated Circuit (ASIC), an electronic circuit, a processor (shared, dedicated, or group), and/or memory (shared, dedicated, or group) that execute one or more software or firmware programs, a combinational logic circuit, and/or other suitable hardware components that provide the described functionality.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled” and “connected” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus, the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code to reduce the number of times code must be retrieved from bulk storage during execution. The term “code” covers a broad range of software components and constructs, including applications, drivers, processes, routines, methods, modules, firmware, microcode, and subprograms. Thus, the term “code” may be used to refer to any collection of instructions which, when executed by a processing system, perform a desired operation or operations.

Processing circuitry, logic circuitry, devices, and interfaces herein described may perform functions implemented in hardware and also implemented with code executed on one or more processors. Processing circuitry, or logic circuitry, refers to the hardware or the hardware and code that implements one or more logical functions. Circuitry is hardware and may refer to one or more circuits. Each circuit may perform a particular function. A circuit of the circuitry may comprise discrete electrical components interconnected with one or more conductors, an integrated circuit, a chip package, a chip set, memory, or the like. Integrated circuits include circuits created on a substrate such as a silicon wafer and may comprise components. And integrated circuits, processor packages, chip packages, and chipsets may comprise one or more processors.

Processors may receive signals such as instructions and/or data at the input(s) and process the signals to generate the at least one output. While executing code, the code changes the physical states and characteristics of transistors that make up a processor pipeline. The physical states of the transistors translate into logical bits of ones and zeros stored in registers within the processor. The processor can transfer the physical states of the transistors into registers and transfer the physical states of the transistors to another storage medium.

A processor may comprise circuits or circuitry to perform one or more sub-functions implemented to perform the overall function of “a processor”. Note that “a processor” may comprise one or more processors and each processor may comprise one or more processor cores that independently or interdependently process code and/or data. Each of the processor cores are also “processors” and are only distinguishable from processors for the purpose of describing a physical arrangement or architecture of a processor with multiple processor cores on one or more dies and/or within one or more chip packages. Processor cores may comprise general processing cores or may comprise processor cores configured to perform specific tasks, depending on the design of the processor. Processor cores may be processors with one or more processor cores. As discussed and claimed herein, when discussing functionality performed by a processor, processing circuitry, or the like; the processor, processing circuitry, or the like may comprise one or more processors, each processor having one or more processor cores, and any one or more of the processors and/or processor cores may reside on one or more dies, within one or more chip packages, and may perform part of or all the processing required to perform the functionality.

One example of a processor is a state machine or an application-specific integrated circuit (ASIC) that includes at least one input and at least one output. A state machine may manipulate the at least one input to generate the at least one output by performing a predetermined series of serial and/or parallel manipulations or transformations on the at least one input.

Several embodiments have one or more potentially advantages effects. The enhancements advantageously enable network-based sensing in a cellular network. For instance, parsing an application function (AF) request from an AF, the AF request comprising a first set of parameters, the first set of parameters comprising a first geographical arca and a sensing type may advantageously provide an interface for service discovery and for servicing requests for network-based processing. Identifying a radio access network (RAN) node based on the first geographical area may advantageously identify appropriate network-based sensing equipment for servicing requests for network-based processing. Sending a sensing request to the RAN node, the sensing request comprising a second set of parameters to identify sensing information, the second set of parameters comprising a second geographical area and a sensing type may advantageously distribute AF requests for servicing requests for network-based processing. Receiving a sensing result from the RAN node based on the second set of parameters may advantageously collect sensor information for servicing requests for network-based processing. Processing the sensing result based on the AF request to determine a sensing report may advantageously process sensor information for reporting servicing requests for network-based processing. Sending, to the AF, the sensing report via the network interface may advantageously route sensing reports for servicing requests for network-based processing.

### EXAMPLES OF FURTHER EMBODIMENTS

The following examples pertain to further embodiments. Specifics in the examples may be used anywhere in one or more embodiments.

Example 1 is an apparatus to perform network-based sensing, comprising a network interface for network communications; logic circuitry coupled with the interface to perform operations to parse an application function (AF) request from an AF, the AF request comprising a first set of parameters, the first set of parameters comprising a first geographical area and a sensing type; identify a radio access network (RAN) node based on the first geographical area; send a sensing request to the RAN node, the sensing request comprising a second set of parameters to identify sensing information, the second set of parameters comprising a second geographical area and a sensing type; receive a sensing result from the RAN node based on the second set of parameters; process the sensing result based on the AF request to determine a sensing report; and send, to the AF, the sensing report via the network interface. In Example 2, the apparatus of claim 1, wherein the logic circuitry comprises a processor and a memory coupled with the processor, the apparatus further comprising a radio frequency circuitry coupled with the logic circuitry, and one or more antennas coupled with the radio frequency circuitry. In Example 3, the apparatus of claim 1, wherein the first set of parameters further comprises a quality of service (QoS) level, wherein the operations to identify the RAN node further comprise operations to identify a set of RAN nodes including the RAN node, wherein the set of RAN nodes are proximate to the first geographical area. In Example 4, the apparatus of claim 3, the operations further to generate a sensing request for each of the RAN nodes in the set of RAN nodes. In Example 5, the apparatus of claim 3, wherein the operations to send the sensing request to the RAN node comprises operations to send sensing requests to each of the RAN nodes in the set of RAN nodes, wherein second set of parameters further comprise a reporting mode, a frequency of reporting, the QoS level, or a combination thereof. In Example 6, the apparatus of claim 1, wherein the sensing information comprises network-based sensor data processed by the RAN node to indicate an object shape, an object velocity, air pollution intensity, or rainfall intensity, based on one or more objects proximate to the RAN node, the network-based sensor data based on receipt of echoes of directional radio signals transmitted by the RAN node and reflected back to the RAN node. In Example 7, the apparatus of claim 1, wherein the operations further determine, based on processing the sensing result, whether to request an additional sensing result from the RAN node to increase a granularity of the sensing result, the operations to send the sensing report to comprise operations to send the sensing report via a Network Exposure Function (NEF), wherein the sensing report comprises a third geographical area and a map indicative of rainfall intensity based on the third geographical area, a map indicative of air pollution based on the third geographical area, an object shape, or an object velocity, wherein the third geographical area is a portion of or all the first geographical area. In Example 8, the apparatus of any one of claims 1-7, wherein communications between a Sensing Service Management Function (SSMF) and the RAN node or the set of RAN nodes are sent via the Access and Mobility Function (AMF).

Example 9 is a method to perform network-based sensing, comprising parsing an application function (AF) request from an AF, the AF request comprising a first set of parameters, the first set of parameters comprising a first geographical area and a sensing type; identifying a radio access network (RAN) node based on the first geographical area; sending a sensing request to the RAN node, the sensing request comprising a second set of parameters to identify sensing information, the second set of parameters comprising a second geographical area and a sensing type; receiving a sensing result from the RAN node based on the second set of parameters; processing the sensing result based on the AF request to determine a sensing report; and sending, to the AF, the sensing report via the network interface. In Example 10, the method of claim 9, wherein the first set of parameters further comprises a quality of service (QoS) level, wherein the operations to identify the RAN node further comprise operations to identify a set of RAN nodes including the RAN node, wherein the set of RAN nodes are proximate to the first geographical area. In Example 11, the method of claim 10, further comprising generating a sensing request for each of the RAN nodes in the set of RAN nodes. In Example 12, the method of claim 10, wherein sending the sensing request to the RAN node comprises sending sensing requests to each of the RAN nodes in the set of RAN nodes, wherein second set of parameters further comprise a reporting mode, a frequency of reporting, the QoS level, or a combination thereof. In Example 13, the method of claim 9, wherein the sensing information comprises network-based sensor data processed by the RAN node to indicate an object shape, an object velocity, air pollution intensity, or rainfall intensity, based on one or more objects proximate to the RAN node, the network-based sensor data based on receipt of echoes of directional radio signals transmitted by the RAN node and reflected back to the RAN node. In Example 14, the method of any claim 9-11, further comprising determining, based on processing the sensing result, whether to request an additional sensing result from the RAN node to increase a granularity of the sensing result, wherein sending the sensing report comprises sending the sensing report via a Network Exposure Function (NEF), wherein communications between the SSMF and the RAN node or the set of RAN nodes are sent via the Access and Mobility Function (AMF).

Example 15 is a machine-readable medium containing instructions, which when executed by a processor, cause the processor to perform operations, the operations to parse an application function (AF) request from an AF, the AF request comprising a first set of parameters, the first set of parameters comprising a first geographical area and a sensing type; identify a radio access network (RAN) node based on the first geographical area; send a sensing request to the RAN node, the sensing request comprising a second set of parameters to identify sensing information, the second set of parameters comprising a second geographical area and a sensing type; receive a sensing result from the RAN node based on the second set of parameters; process the sensing result based on the AF request to determine a sensing report; and send, to the AF, the sensing report via the network interface. In Example 16, the machine-readable medium of claim 15, wherein the first set of parameters further comprises a quality of service (QoS) level, wherein the operations to identify the RAN node further comprise operations to identify a set of RAN nodes including the RAN node, wherein the set of RAN nodes are proximate to the first geographical arca. In Example 17, the machine-readable medium of claim 16, the operations further to generate a sensing request for each of the RAN nodes in the set of RAN nodes. In Example 18, the machine-readable medium of claim 16, wherein the operations to send the sensing request to the RAN node comprises operations to send sensing requests to each of the RAN nodes in the set of RAN nodes, wherein second set of parameters further comprise a reporting mode, a frequency of reporting, the QoS level, or a combination thereof. In Example 19, the machine-readable medium of claim 15, wherein the sensing information comprises network-based sensor data processed by the RAN node to indicate an object shape, an object velocity, air pollution intensity, or rainfall intensity, based on one or more objects proximate to the RAN node, the network-based sensor data based on receipt of echoes of directional radio signals transmitted by the RAN node and reflected back to the RAN node. In Example 20, the machine-readable medium of any claim 15-19, wherein communications between the SSMF and the RAN node or the set of RAN nodes are sent via the Access and Mobility Function (AMF).

Example 21 is an apparatus comprising a means for any Example 9-14.

1-20. (canceled)

21. An apparatus to perform network-based sensing, comprising:
a network interface for network communications;
logic circuitry coupled with the interface to perform operations to:
parse an application function (AF) request from an AF, the AF request comprising a first set of parameters, the first set of parameters comprising a first geographical area and a sensing type;
identify a radio access network (RAN) node based on the first geographical area;
send a sensing request to the RAN node, the sensing request comprising a second set of parameters to identify sensing information, the second set of parameters comprising a second geographical area and a sensing type;
receive a sensing result from the RAN node based on the second set of parameters;
process the sensing result based on the AF request to determine a sensing report; and
send, to the AF, the sensing report via the network interface.

22. The apparatus of claim 21, wherein the logic circuitry comprises a processor and a memory coupled with the processor, the apparatus further comprising a radio frequency circuitry coupled with the logic circuitry, and one or more antennas coupled with the radio frequency circuitry.

23. The apparatus of claim 21, wherein the first set of parameters further comprises a quality of service (QoS) level, wherein the operations to identify the RAN node further comprise operations to identify a set of RAN nodes including the RAN node, wherein the set of RAN nodes are proximate to the first geographical area.

24. The apparatus of claim 23, the operations further to generate a sensing request for each of the RAN nodes in the set of RAN nodes.

25. The apparatus of claim 23, wherein the operations to send the sensing request to the RAN node comprises operations to send sensing requests to each of the RAN nodes in the set of RAN nodes, wherein second set of parameters further comprise a reporting mode, a frequency of reporting, the QoS level, or a combination thereof.

26. The apparatus of claim 21, wherein the sensing information comprises network-based sensor data processed by the RAN node to indicate an object shape, an object velocity, air pollution intensity, or rainfall intensity, based on one or more objects proximate to the RAN node, the network-based sensor data based on receipt of echoes of directional radio signals transmitted by the RAN node and reflected back to the RAN node.

27. The apparatus of claim 21, wherein the operations further determine, based on processing the sensing result, whether to request an additional sensing result from the RAN node to increase a granularity of the sensing result, the operations to send the sensing report to comprise operations to send the sensing report via a Network Exposure Function (NEF), wherein the sensing report comprises a third geographical area and a map indicative of rainfall intensity based on the third geographical area, a map indicative of air pollution based on the third geographical area, an object shape, or an object velocity, wherein the third geographical area is a portion of or all the first geographical area.

28. The apparatus of claim 21, wherein communications between a Sensing Service Management Function (SSMF) and the RAN node or the set of RAN nodes are sent via the Access and Mobility Function (AMF).

29. A method to perform network-based sensing, comprising:
parsing an application function (AF) request from an AF, the AF request comprising a first set of parameters, the first set of parameters comprising a first geographical area and a sensing type;
identifying a radio access network (RAN) node based on the first geographical area;
sending a sensing request to the RAN node, the sensing request comprising a second set of parameters to identify sensing information, the second set of parameters comprising a second geographical area and a sensing type;
receiving a sensing result from the RAN node based on the second set of parameters;
processing the sensing result based on the AF request to determine a sensing report; and
sending, to the AF, the sensing report via the network interface.

30. The method of claim 29, wherein the first set of parameters further comprises a quality of service (QoS) level, wherein the operations to identify the RAN node further comprise operations to identify a set of RAN nodes including the RAN node, wherein the set of RAN nodes are proximate to the first geographical area.

31. The method of claim 30, further comprising generating a sensing request for each of the RAN nodes in the set of RAN nodes.

32. The method of claim 30, wherein sending the sensing request to the RAN node comprises sending sensing requests to each of the RAN nodes in the set of RAN nodes, wherein second set of parameters further comprise a reporting mode, a frequency of reporting, the QoS level, or a combination thereof.

33. The method of claim 29, wherein the sensing information comprises network-based sensor data processed by the RAN node to indicate an object shape, an object velocity, air pollution intensity, or rainfall intensity, based on one or more objects proximate to the RAN node, the network-based sensor data based on receipt of echoes of directional radio signals transmitted by the RAN node and reflected back to the RAN node.

34. The method of claim 29, further comprising determining, based on processing the sensing result, whether to request an additional sensing result from the RAN node to increase a granularity of the sensing result, wherein sending the sensing report comprises sending the sensing report via a Network Exposure Function (NEF), wherein communications between a Sensing Service Management Function (SSMF) and the RAN node or the set of RAN nodes are sent via the Access and Mobility Function (AMF).

35. A machine-readable medium containing instructions, which when executed by a processor, cause the processor to perform operations, the operations to:
parse an application function (AF) request from an AF, the AF request comprising a first set of parameters, the first set of parameters comprising a first geographical area and a sensing type;
identify a radio access network (RAN) node based on the first geographical area;
send a sensing request to the RAN node, the sensing request comprising a second set of parameters to identify sensing information, the second set of parameters comprising a second geographical area and a sensing type;
receive a sensing result from the RAN node based on the second set of parameters;
process the sensing result based on the AF request to determine a sensing report; and
send, to the AF, the sensing report via the network interface.

36. The machine-readable medium of claim 35, wherein the first set of parameters further comprises a quality of service (QoS) level, wherein the operations to identify the RAN node further comprise operations to identify a set of RAN nodes including the RAN node, wherein the set of RAN nodes are proximate to the first geographical area.

37. The machine-readable medium of claim 36, the operations further to generate a sensing request for each of the RAN nodes in the set of RAN nodes.

38. The machine-readable medium of claim 36, wherein the operations to send the sensing request to the RAN node comprises operations to send sensing requests to each of the RAN nodes in the set of RAN nodes, wherein second set of parameters further comprise a reporting mode, a frequency of reporting, the QoS level, or a combination thereof.

39. The machine-readable medium of claim 35, wherein the sensing information comprises network-based sensor data processed by the RAN node to indicate an object shape, an object velocity, air pollution intensity, or rainfall intensity, based on one or more objects proximate to the RAN node, the network-based sensor data based on receipt of echoes of directional radio signals transmitted by the RAN node and reflected back to the RAN node.

40. The machine-readable medium of claim 35, wherein communications between a Sensing Service Management Function (SSMF) and the RAN node or the set of RAN nodes are sent via the Access and Mobility Function (AMF).
